(19) United States
(12) Patent Application Publication
(10) Pub. No.: US 2015/0238874 A1
(43) Pub. Date: Aug. 27, 2015

(54) GAME CONTROL SERVER APPARATUS

(71) Applicant: DeNA Co., Ltd., Tokyo (JP)

(72) Inventors: Yoshinori ONO, Tokyo (JP); Shiina SUZUKI, Tokyo (JP)

(21) Appl. No.: 14/627,110

(22) Filed: Feb. 20, 2015

(30) Foreign Application Priority Data
Feb. 26, 2014 (JP) 2014-036013

(51) Int. Cl. A63F 13/847; A63F 13/825; A63F 13/35

(52) U.S. Cl. CPC A63F 13/847; A63F 13/35; A63F 13/825

(57) ABSTRACT

A game control server apparatus includes an event game providing unit that provides an event game in which a predetermined capture item is provided to appear on a predetermined grow item grown at a field of each of the players and the predetermined capture item is captured based on a capturing instruction from each of the players; an object providing unit that gives a predetermined decorative object at a timing when a performance result by the player satisfies a predetermined condition; and a probability varying item providing unit that evaluates a performance of each of the players based on a predetermined action performed by the respective player from a start to an end of the period of the first event game, and gives a probability varying item that is permitted to be used in a following or later event game to a player whose performance is good.

### CROSS-REFERENCE TO RELATED APPLICATION

The present application is based on and claims the benefit of priority of Japanese Priority Application No. 2014-036013 filed on Feb. 26, 2014, the entire contents of which are hereby incorporated by reference.

### BACKGROUND OF THE INVENTION

1. Field of the Invention

The present invention relates to a game control server apparatus.

2. Description of the Related Art

Conventionally, a farm game is known in which a player seeds a plant object, waters the plant object, harvests the plant object or the like in a farm (my farm) that is allocated to the player (Patent Document 1).

In such a farm game, the player can set a decorative object such as a fence, a background image or the like obtained in the game in the player's farm in addition to harvesting the plant object or the like. Players can view plant objects grown by other players in their farms or decorative objects set in their farms, and can send messages with each other. For example, a player can send a feedback of an appearance of other player's farm as a message such as “your farm is pretty!” or the like so that the players can communicate with each other.

Here, such a decorative object is given to a player in an event game, that is held during a predetermined period such as two weeks or the like, who clears a predetermined condition of the event game within the period. Specifically, for example, a decorative object is given to a player when the player clears a condition such as capturing a predetermined number of predetermined animal objects that appear on predetermined plant objects set in the event game in the player's farm after seeding the predetermined plant objects in the player's farm or the like within the period of the event game. When a player who obtains the decorative object sets the decorative object in the player's farm, other players can recognize the decorative object and may send an admiration message such as “Do you already get a new fence!? Great!!” or the like. Thus, it is also a pleasure of the game for players to clear the condition of the event game to obtain a new decorative object as soon as possible, set the decorative object in the player's farm as soon as possible and obtain admirations from other players.

Further, if a player cannot clear the predetermined condition within the period of the event game, the player cannot obtain the decorative object. Thus, players play the game hard to clear the predetermined condition within the period of the event game.

However, by adopting a configuration like this in which the decorative object is given to each of the players when the respective player clears the predetermined condition during the period of the event game, for example, for the player who clears the predetermined condition and obtains the decorative object at a relative early period within the period of the event game, there is a problem that the player may lose motivation to continue the event game even the period of the event game is left.

### Patent Document

### [Patent Document 1] Japanese Laid-open Patent Publication No. 2014-23864

### SUMMARY OF THE INVENTION

The present invention is made in light of the above problems, and provides a technique capable of improving motivation of a player to continue an event game even after the player clears a predetermined condition of the event game while giving a decorative object, which is a reward, to the player at the time when the player clears the predetermined condition within an event game period.

According to an embodiment, there is provided a game control server apparatus connected to a plurality of terminal devices of a plurality of players via a network to enable communication between players and providing a game in which each of the players grows an item in a field of the player, the game control server apparatus including: an event game providing unit that provides an event game in which a predetermined capture item is provided to appear on a predetermined grow item grown at a field of each of the players and the predetermined capture item is captured based on a capturing instruction from each of the players, a period being set for the event game; an object providing unit that gives a predetermined decorative object for decorating a field to a player at a timing when a performance result by the player of capturing the capture item in the field of the player satisfies a predetermined condition while the event game is being held; and a probability varying item providing unit that evaluates a performance of each of the players in a first event game based on a predetermined action performed by the respective player from a start to an end of the period of the first event game in the first event game, and gives a probability varying item that is permitted to be used in a following or later event game to a player whose performance is good.

Here, when a player uses the probability varying item that is permitted to be used in a current event game, the event game providing unit varies a probability of at least a process that is controlled by a predetermined probability in the current event game toward a direction that the player can satisfy the predetermined condition easier based on a setting to the probability varying item.

According to another embodiment, there is provided a game control server apparatus connected to a plurality of terminal devices of a plurality of players via a network to enable communication between players and providing a game in which each of the players grows an item in a field of the player, the game control server apparatus including: an event game providing unit that provides an event game in which a predetermined capture item is provided to appear on a predetermined grow item grown at a field of each of the players and the predetermined capture item is captured based on a capturing instruction from each of the players, a period being set for the event game; an object providing unit that gives a predetermined decorative object for decorating a field to a player at a timing when a performance result by the player of capturing the capture item in the field of the player satisfies a predetermined condition while the event game is being held; and a probability varying item providing unit that evaluates a performance of each of the players in a first event game based on a predetermined action performed by the respective player from a start to an end of the period of the first event game in the first event game, and gives a probability varying item that is permitted to be used in a following or later event game to a player whose performance is good, wherein the event game providing unit provides the predetermined capture item on the predetermined grow item in accordance with a random selection based on a predetermined appearance probability, and wherein when a player uses the probability varying item that is permitted to be used in a current event game, the event game providing unit increases an appearance probability of the predetermined capture item on the predetermined grow item grown in the field of the player to be larger than the predetermined appearance probability based on a setting to the probability varying item.

According to another embodiment, there is provided a game control server apparatus connected to a plurality of terminal devices of a plurality of players via a network to enable communication between players and providing a game in which each of the players grows an item in a field of the player, the game control server apparatus including: an event game providing unit that provides an event game in which a predetermined capture item is provided to appear on a predetermined grow item grown at a field of each of the players and the predetermined capture item is captured based on a capturing instruction from each of the players, a period being set for the event game; an object providing unit that gives a predetermined decorative object for decorating a field to a player at a timing when a performance result by the player of capturing the capture item in the field of the player satisfies a predetermined condition while the event game is being held; a probability varying item providing unit that evaluates a performance of each of the players in a first event game based on a predetermined action performed by the respective player from a start to an end of the period of the first event game in the first event game, and gives a probability varying item that is permitted to be used in a following or later event game to a player whose performance is good; and a player information storing unit that stores information of an item possessed by each of the players in correspondence with the respective player, wherein the event game providing unit gives a seed item of a predetermined grow item to a first player in accordance with a random selection based on a predetermined seed feeding probability when the first player releases a possessing predetermined capture item on a grow item grown in a field of another second player to have the predetermined capture item appear on the grow item, and wherein when the first player or the second player uses the probability varying item that is permitted to be used in a current event game, the event game providing unit increases a seed feeding probability of the seed item in the field of the second player to be larger than the predetermined seed feeding probability and gives the seed item of the predetermined grow item to the first player in accordance with a random selection based on the increased seed feeding probability.

According to another embodiment, there is provided a game control server apparatus connected to a plurality of terminal devices of a plurality of players via a network to enable communication between players and providing a game in which each of the players grows an item in a field of the player, the game control server apparatus including: an event game providing unit that provides an event game in which a predetermined capture item is provided to appear on a predetermined grow item grown at a field of each of the players and the predetermined capture item is captured based on a capturing instruction from each of the players, a period being set for the event game; an object providing unit that gives a predetermined decorative object for decorating a field to a player at a timing when a performance result by the player of capturing the capture item in the field of the player satisfies a predetermined condition while the event game is being held; and a probability varying item providing unit that evaluates a performance of each of the players in a first event game based on a predetermined action performed by the respective player from a start to an end of the period of the first event game in the first event game, and gives a probability varying item that is permitted to be used in a following or later event game to a player whose performance is good, wherein the event game providing unit gives a seed item of a predetermined grow item to a first player in accordance with a random selection based on a predetermined seed feeding probability when the first player helps to capture a predetermined capture item that appears on a grow item grown in a field of another second player, and wherein when the first player or the second player uses the probability varying item that is permitted to be used in a current event game, the event game providing unit increases a seed feeding probability of the seed item in the field of the second player to be larger than the predetermined seed feeding probability and gives the seed item of the predetermined grow item to the first player in accordance with a random selection based on the increased seed feeding probability.

Note that also arbitrary combinations of the above-described elements, and any changes of expressions in the present invention, made among methods, devices, systems, recording media, computer programs and so forth, are valid as embodiments of the present invention.

### BRIEF DESCRIPTION OF THE DRAWINGS

Other objects, features and advantages of the present invention will become more apparent from the following detailed description when read in conjunction with the accompanying drawings.

FIG. 1 is a block diagram illustrating an example of a system structure of an embodiment;

FIG. 2 is a block diagram illustrating an example of a hardware structure of a terminal device of the embodiment;

FIG. 3 is a block diagram illustrating an example of a hardware structure of a game control server apparatus of the embodiment;

FIG. 4 is a block diagram illustrating an example of functional structures of the terminal device and the game control server apparatus of the embodiment;

FIG. 5 is a view illustrating an example of a game screen provided by the game control server apparatus of the embodiment;

FIG. 6 is a flowchart illustrating an example of a process of the game control server apparatus of the embodiment;

FIG. 7 is a view illustrating an example of a game screen provided by the game control server apparatus of the embodiment;

FIG. 8 is a view illustrating an example of a game screen provided by the game control server apparatus of the embodiment;

FIG. 9 is a view illustrating an example of a game screen provided by the game control server apparatus of the embodiment;

FIG. 10 is a view illustrating an example of a game screen provided by the game control server apparatus of the embodiment;

FIG. 11 is a flowchart illustrating an example of a process of the game control server apparatus of the embodiment;

FIG. 12 is a view illustrating an example of an internal structure of an event game information storing unit of the embodiment;

FIG. 13 is a view illustrating an example of an internal structure of a player information storing unit of the embodiment;

FIG. 14 is a view illustrating an example of an internal structure of a farm information storing unit of the embodiment;

FIG. 15 is a view illustrating an example of an internal structure of an item information storing unit of the embodiment;

FIG. 16 is a flowchart illustrating an example of a process of the game control server apparatus of the embodiment;

FIG. 17 is a flowchart illustrating an example of a process of the game control server apparatus of the embodiment;

FIG. 18 is a view illustrating another example of an internal structure of the event game information storing unit of the embodiment;

FIG. 19 is a flowchart illustrating another example of a process of the game control server apparatus of the embodiment;

FIG. 20 is a flowchart illustrating another example of a process of the game control server apparatus of the embodiment;

FIG. 21 is a view illustrating another example of an internal structure of the event game information storing unit of the embodiment;

FIG. 22 is a flowchart illustrating another example of a process of the game control server apparatus of the embodiment; and

FIG. 23 is a view illustrating an example of a game screen provided by the game control server apparatus of the embodiment.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

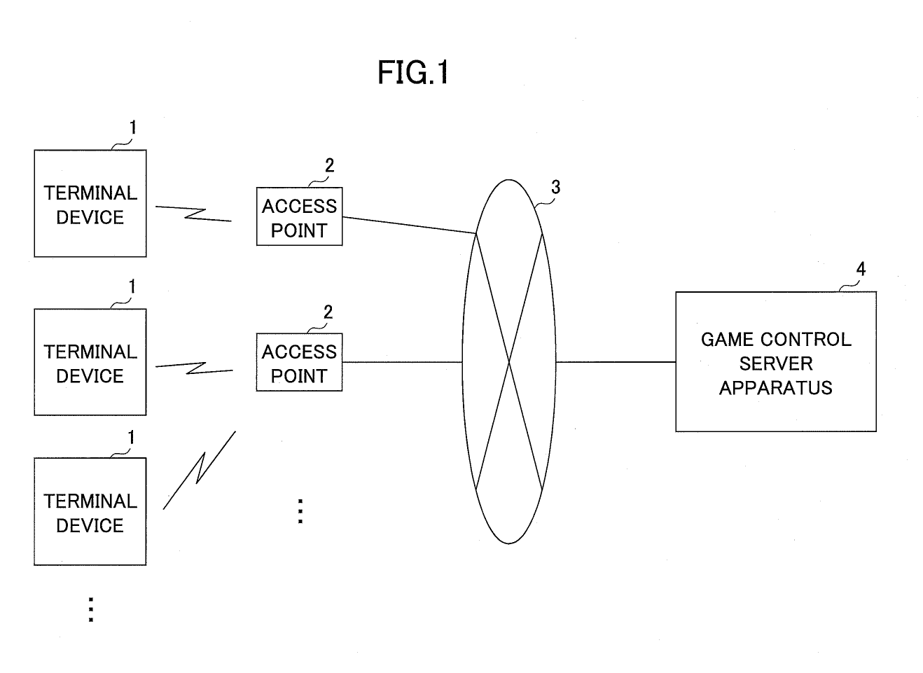

FIG. 1 is a block diagram illustrating an example of a system structure of the embodiment.

The system includes a plurality of terminal devices 1 each possessed by a player (user), access points 2 such as a mobile station, a Wi-Fi station or the like, a network 3 such as the INTERNET or the like and a game control server apparatus 4 that manages (controls) a game played by the plurality of players via the network 3. The game control server apparatus 4 is connected to the terminal devices 1 of the plurality of players via the network 3. The terminal device 1 may be a data processing apparatus such as a mobile phone, a smartphone, a game console, a personal computer, a touch pad, a digital book reader or the like.

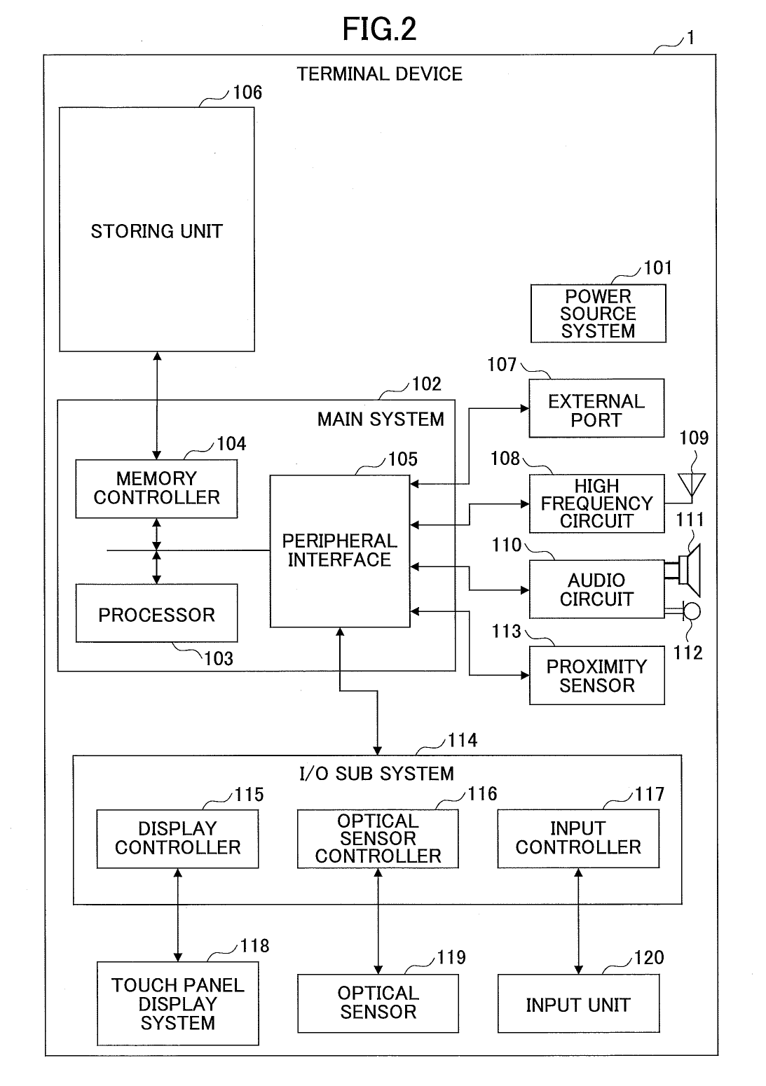

FIG. 2 is a block diagram illustrating an example of a hardware structure of the terminal device 1 of the embodiment.

The terminal device 1 includes a power source system 101, a main system 102, a storing unit 106, an external port 107, a high frequency circuit 108, an antenna 109, an audio circuit 110, a speaker 111, a microphone 112, a proximity sensor 113, an I/O (Input/Output) sub system 114, a touch panel display system 118, an optical sensor 119 and an input unit 120. The main system 102 includes a processor 103, a memory controller 104 and a peripheral interface 105. The I/O sub system 114 includes a display controller 115, an optical sensor controller 116 and an input controller 117.

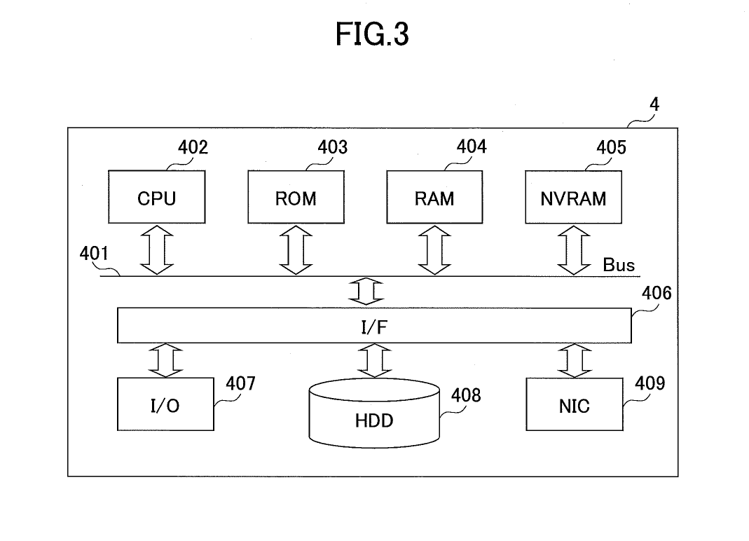

FIG. 3 is a block diagram illustrating an example of a hardware structure of the game control server apparatus 4 of the embodiment.

The game control server apparatus 4 includes a CPU (Central Processing Unit) 402, a ROM (Read Only Memory) 403, a RAM (Random Access Memory) 404, an NVRAM (Non-Volatile Random Access Memory) 405 and an I/F (Interface) 406 connected to a system bus 401, an I/O (Input/Output Device) 407 for a keyboard, a mouse, a monitor, a CD/DVD (Compact Disk/Digital Versatile Disk) drive or the like, an HDD (Hard Disk Drive) 408 and an NIC (Network Interface Card) 409 connected to the I/F 406 and the like.

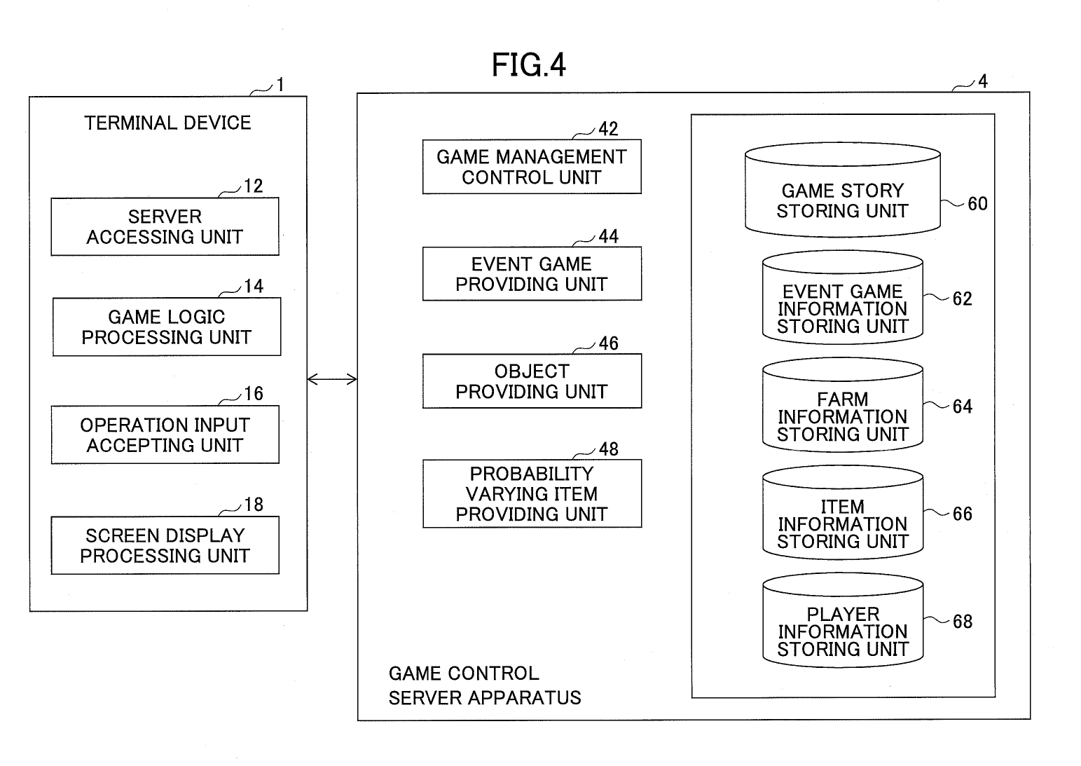

FIG. 4 is a block diagram illustrating an example of functional structures of the terminal device 1 and the game control server apparatus 4.

The terminal device 1 includes a server accessing unit 12, a game logic processing unit 14, an operation input accepting unit 16 and a screen display processing unit 18.

The operation input accepting unit 16 accepts an operation input from a player (user) who operates the terminal device 1.

The game logic processing unit 14 processes a game by transitioning screens in accordance with an input operation of the player accepted by the operation input accepting unit 16.

The server accessing unit 12 sends a request to the game control server apparatus 4 and receives a processed result or the like as a response from the game control server apparatus 4 when it is necessary to access the game control server apparatus 4 in a course of the processing by the game logic processing unit 14.

The screen display processing unit 18 displays screens under control of the game logic processing unit 14.

The game control server apparatus 4 includes a game management control unit 42, an event game providing unit 44, an object providing unit 46, a probability varying item providing unit 48, a game story storing unit 60, an event game information storing unit 62, a farm information storing unit 64, an item information storing unit 66 and a player information storing unit 68.

The game story storing unit 60 stores a game story or the like for performing the game of the embodiment. In this embodiment, the game control server apparatus 4 provides a game in which each player grows items at a farm of himself/herself including a field.

The game management control unit 42 controls the entirety of the game control server apparatus 4. The game management control unit 42, based on a request from the terminal device 1, processes a process along with the game story by referring to the game story storing unit 60, and sends a processed result of the request to the terminal device 1 as a response, for example. The game management control unit 42 provides a farm of each of the players to be capable of being viewed by other players. Further, the game management control unit 42 provides a communication function by which players can send and receive messages with each other.

The event game providing unit 44 provides an event game for which a period such as two weeks or the like, for example, is set. Specifically, in the event game, when a player seeds a seed item of a predetermined item to grow (hereinafter, referred to as a “grow item”) at a block of his/her own field, the grow item becomes capable of being harvested after a growing period that is set for the grow item to grow. The grow item may be a vegetable, a flower or the like, for example. However, in the event game, the grow item may not be limited to an existing vegetable, flower or the like, and may be a fictitious crop or plant that imitates a vegetable, a flower or the like.

The event game providing unit 44 provides a predetermined item to capture (hereinafter, referred to as a “capture item”) to appear on the grow item grown at the field of each of the players at a timing when the grow item becomes capable of being harvested in accordance with a random selection based on a predetermined appearance probability. The capture item may be an animal or the like, for example. However, in the event game, the capture item may not be limited to an existing animal or the like, and may be a fictitious character. Here, the random selection based on the predetermined appearance probability means to randomly determine whether to provide the predetermined capture item to appear based on an appearance probability “a” % and a non-appearance probability “100−a” %.

Further, the event game providing unit 44 captures the capture item in accordance with a random selection based on a predetermined capturing probability by a capturing instruction from the player. Here, the random selection based on the predetermined capturing probability means to randomly determine whether to capture the predetermined capture item based on a capturing probability “b” % and a non-capturing probability “100−b” %.

The object providing unit 46 gives a predetermined decorative object for decorating the farm (field) such as a fence, a background image or the like, for example, to a player when a performance result of the player of capturing the capture items in the player's own field satisfies a predetermined condition during the event game is held. The performance result of the player of capturing the capture items in the player's own field means to capture a predetermined number of the capture items set in the event game, for example.

The probability varying item providing unit 48 evaluates a performance of each of the players in the event game based on a predetermined action performed by the player in the event game from a start to an end of the period of the event game, and gives a probability varying item that is permitted to be used in a following or later event game to a player whose performance is good. The predetermined action performed by the player means capturing of all of the capture items set in the event game or the like, for example.

Although the probability varying item is explained later in detail, when a player uses a probability varying item that is permitted to be used in a current event game, based on a setting to the probability varying item, the event game providing unit 44 varies a probability of at least one process that is controlled by a predetermined probability in the event game such that the above described predetermined condition is satisfied easier for the player.

The event game information storing unit 62 stores various setting conditions of each stage in the event game. Specifically, the event game information storing unit 62 stores information such as a grow item that is to be grown in each stage of the event game, a growing period necessary for the grow item to grow after being seeded, a capture item that appears on the grow item, an appearance probability (%) of the capture item, a capturing probability (%) of the capture item, a clear condition (the necessary number of capture items to capture or the like) of the stage, a decorative object that is given to a player when the player satisfies the clear condition of the stage or the like.

The farm information storing unit 64 stores various farm information of each of the players who participates in the game. Specifically, the farm information storing unit 64 stores information of a farm of each of the players such as a field status of the farm, a fence set in the farm, a background image set in the farm or the like.

The item information storing unit 66 stores information regarding items used in the game. Specifically, the item information storing unit 66 stores information of each of the items such as icon data, a kind (function), limitation in use or the like.

The player information storing unit 66 stores various player information of all of the players who participate in the game. Specifically, the player information storing unit 68 stores information of each of the players such as a level, icon data, a player name, friend players, possessing money in game, possessing items, farm information or the like.

Next, an event game provided by the event game providing unit 44 is explained.

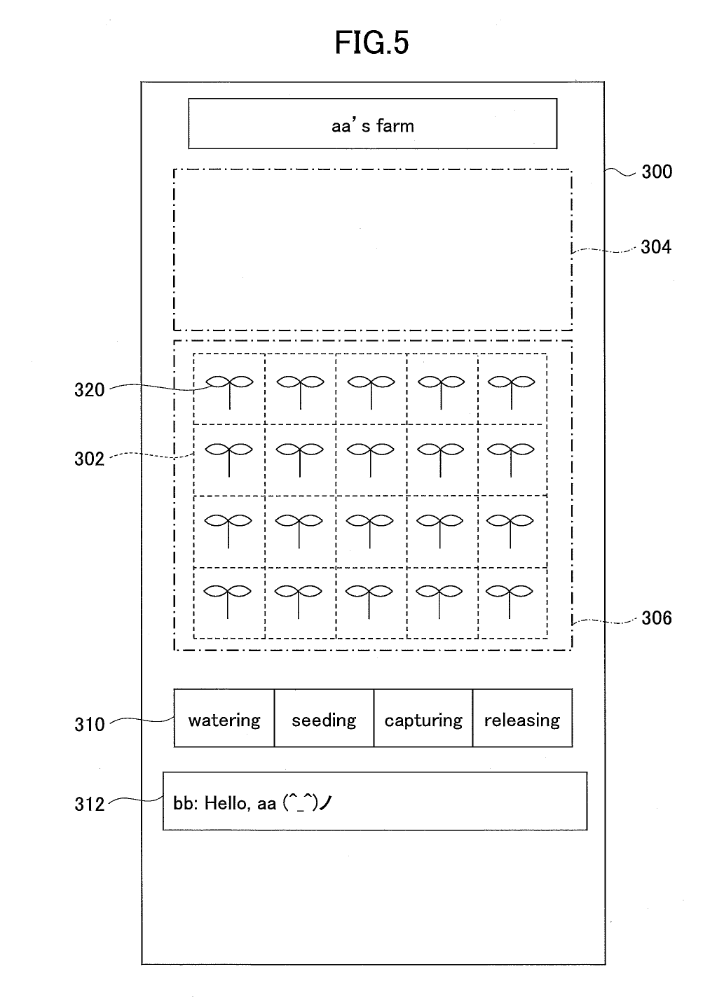

FIG. 5 is a view illustrating an example of a game screen 300 including a field of a player that is displayed to the player, in this embodiment.

The game screen 300 includes a field including a plurality of blocks 302, a fence 306 that surrounds the field, a background image 304 of the field, operation buttons 310, a message display area 312 or the like. For the illustrated example, the field includes 20 blocks 302 of 5 (horizontal)×4 (vertical). The operation buttons 310 include operation buttons such as “watering”, “seeding”, “capturing”, “releasing (sending)” or the like, for example. In the message display area 312, a message or the like from another player is displayed. The decorative object such as a fence, a background image or the like given by the object providing unit 46 is set at the fence 306 and the background image 304, respectively.

In such a game screen 300, when the player operates the terminal device 1 to select a desired operation button from the operation buttons 310, and to select a desired block 302 of the field, the game management control unit 42 performs a process of watering, seeding, capturing, releasing or the like at the selected block 302.

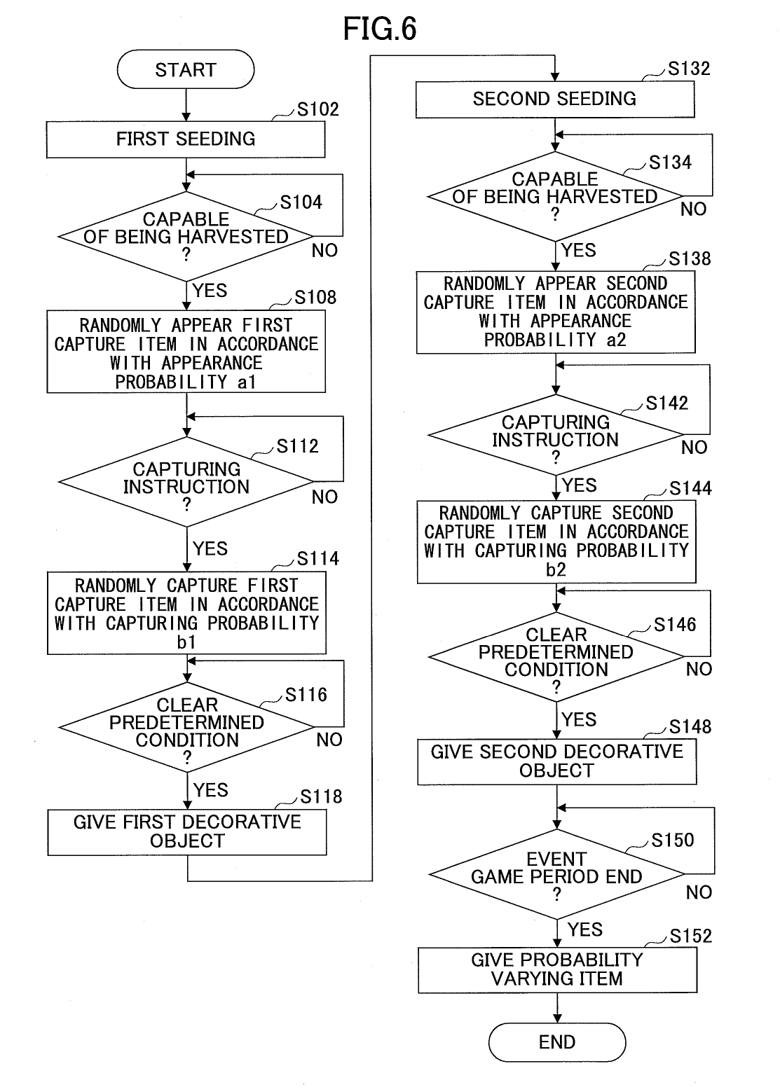

FIG. 6 is a flowchart illustrating an example of processing steps of the game control server apparatus 4 of the embodiment. First, an event game with a setting by which a probability varying item is not used is explained.

Here, as an event game, an example is explained in which following first stage, second stage, . . . are provided. In the first stage, when a player grows a first grow item in his/her field, a first capture item appears on the first grow item. Then, when the player succeeds in capturing a predetermined number of the first capture items, a first decorative object is given to the player. Similarly, in the second stage, when the player grows a second grow item in his/her field, a second capture item appears on the second grow item. Then, when the player succeeds in capturing a predetermined number of the second capture items, second decorative object is given to the player.

First, when the player seeds seed items of a first grow item in his/her field (first seeding), the event game providing unit 44 accepts the operation of the player and displays a status in which the seeding is completed in the game screen 300 (step S102). FIG. 5 illustrates a status in which seed items of a predetermined grow item are seeded at the blocks 302 of the field and plants 320 are growing.

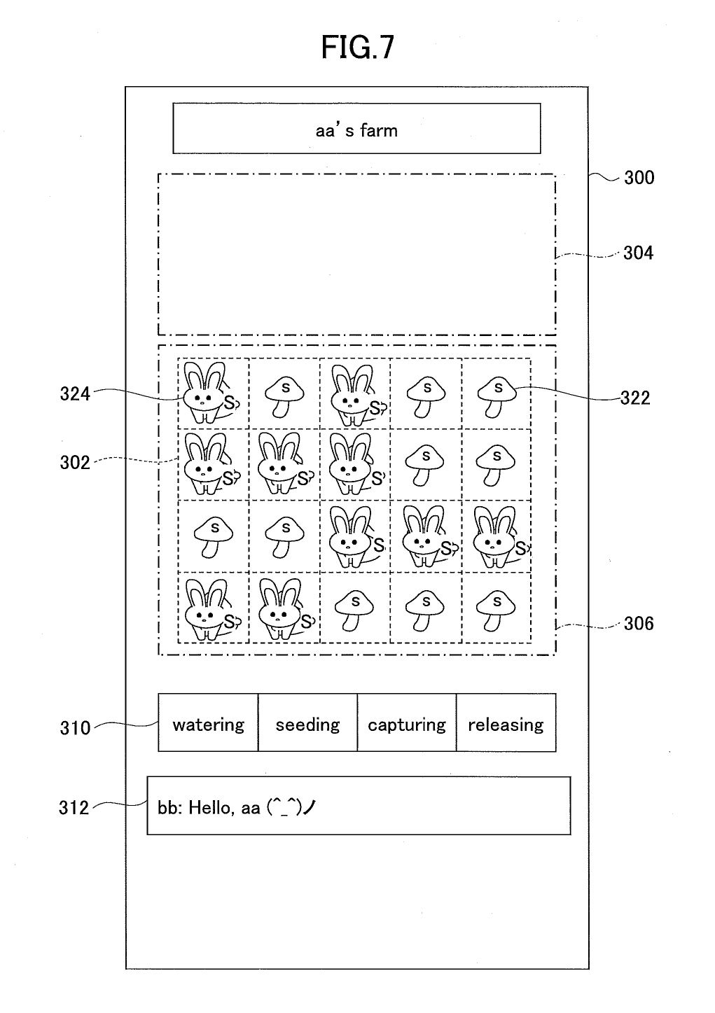

Referring back to FIG. 6, when the first grow item becomes capable of being harvested (YES in step S104), the event game providing unit 44 randomly provides a first capture item to appear on the first grow item in accordance with an appearance probability a1 (step S108). FIG. 7 illustrates a status in which grow items 322 become capable of being harvested at blocks 302 of the field, and capture items 324 are appeared on some of the grow items 322.

Referring back to FIG. 6, when the player instructs to capture (YES in step S112), the event game providing unit 44 randomly captures the first capture item in accordance with a capturing probability b1 (step S114).

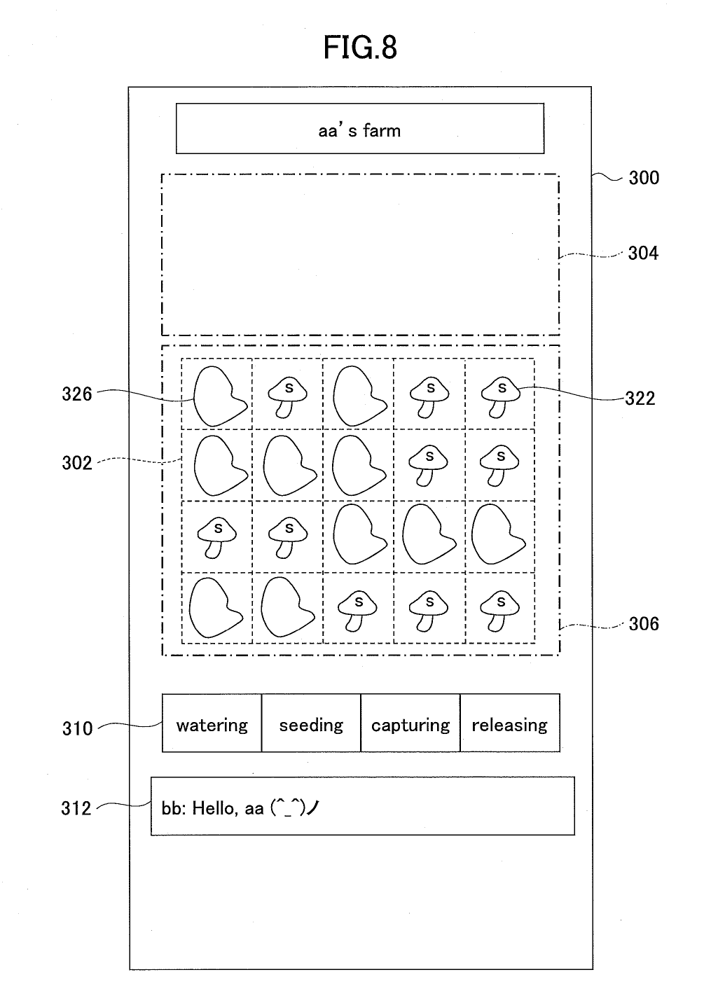

FIG. 8 illustrates a status in which the player sets capturing tools 326 such as nets or the like on the capture items 324 that appear at the blocks 302 of the field, respectively. For example, when the player presses the “capturing” button of the operation buttons 310 to perform an operation to set the capturing tools 326 on the capture items 324, respectively, and presses an “OK” button (not illustrated in the drawings) or the like, the event game providing unit 44 accepts the operation as a capturing instruction. The event game providing unit 44 displays a captured result to the player.

For example, for the example illustrated in FIG. 8, the capturing tools 326 are covered on the 10 capture items 324. Here, as the first capture items are randomly captured in accordance with the capturing probability b1, the number of the capture items 324 that are actually captured becomes different in accordance with a result of a random selection based on the capturing probability b1. For example, when three of the capture items 324 among the 10 capture items 324 are actually captured, the event game providing unit 44 displays a message to the player such as “three first capture items are captured. 7 first capture items are escaped.” or the like. Here, as will be explained later, the captured capture items become possessing items of the player.

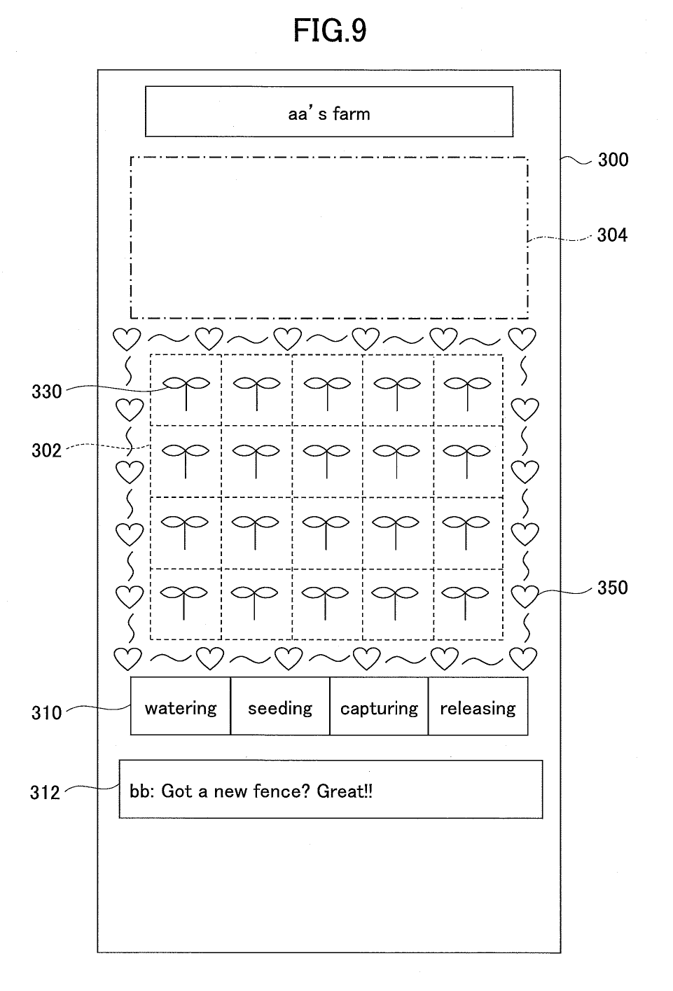

Referring back to FIG. 6, by repeating the above steps and when the player satisfies a previously set predetermined condition such as “capture 8 first capture items” or the like, for example, (YES in step S116), the object providing unit 46 gives a first decorative object to the player (step S118). Then, the process of the first stage is completed. When the given first decorative object is set to be displayed at the player's farm by a request from the player, the game management control unit 42 stores the first decorative object at an area of the farm information storing unit 64 corresponding to the player. FIG. 9 illustrates a status in which a fence 350 is given as the first decorative object, and the player sets the fence 350 to be displayed around the player's field. As such, when the player sets the fence 350 to be displayed, other players can recognize that the player obtains the new fence 350. Thus, the player who sets the fence 350 to be displayed can obtain an admiration from other players such as “Have you already gotten a new fence? Great!!” or the like, for example.

Referring back to FIG. 6, thereafter, steps of the second stage are performed similarly to the first stage. When the player seeds seed items of a second grow item in his/her field (second seeding), the event game providing unit 44 accepts the operation of the player and displays a status in which the seeding is completed in the game screen 300 (step S132).

When the second grow item becomes capable of being harvested (YES in step S134), the event game providing unit 44 randomly provides a second capture item to appear on the second grow item in accordance with an appearance probability a2 (step S138). When the player instructs to capture (YES in step S142), the event game providing unit 44 randomly captures the second capture item in accordance with a capturing probability b2 (step S144).

By repeating the above steps and when the player clears a previously set predetermined condition (YES in step S146), the object providing unit 46 gives a second decorative object to the player (step S148). Then, the process of the second stage is completed. Thereafter, similar steps of a third stage, a fourth stage and the like may be performed.

When the period of the event game ends (YES in step S150), the probability varying item providing unit 48 gives a probability varying item that is permitted to be used in a following or later event game to a player whose performance, is good in the event game (step S152). Whether the player's performance is good may be determined based on points obtained by the player during the event game, for example. For example, the performance of the player may be determined as good when the points obtained by the player is greater than or equal to a predetermined points, when the points obtained by the player is relatively great compared with other players, when the ranking of the player based on the obtained points is at a higher level, or the like.

Specifically, the probability varying item providing unit 48 provides points to each of the players based on a predetermined action performed by the respective player in the event game from a start to an end of the period of the event game and evaluates the performance of the player in the event game by a ranking based on the points provided to each of the players. Here, the predetermined action may be capturing capture items set to be capture in the event game, for example. Thus, in this case, the player may be evaluated based on the number of capture items captured by the player. Next, the probability varying item providing unit 48 gives a probability varying item that is permitted to be used in a following or later event game to the player whose performance is good such as being positioned at a higher rank or the like, for example.

Here, as will be described later, by using the probability varying item in a following or later event game, a player can proceed with the following or later event game advantageously compared with other players who do not use the probability varying item. Thus, the probability varying item is a very attractive reward for players. Thus, according to the game control server apparatus 4 of the embodiment, motivation of a player to clear an event game as early as possible can be increased by giving a decorative object, which is a reward, to the player at the time when the player clears the predetermined condition within an event game period. Further, meanwhile, motivation of the player to continue the event game even after the player clears the predetermined condition of the event game can also be increased by giving a very attractive reward, that is a probability varying item, capable of being used in a following or later event game to a player whose performance is good based on an action of the player from a start to an end of the period of the event game.

Here, the number of the capture items captured by each of the players may be stored in the player information storing unit 68, for example. Then, the object providing unit 46 or the probability varying item providing unit 48 may determine whether the each of the players clears the predetermined condition or evaluate the performance of each of the players based on the number of the capture items stored in the player information storing unit 68.

Here, as described above, according to the embodiment, when the player succeeds in capturing any of the capture items, the player can possess the captured capture item.

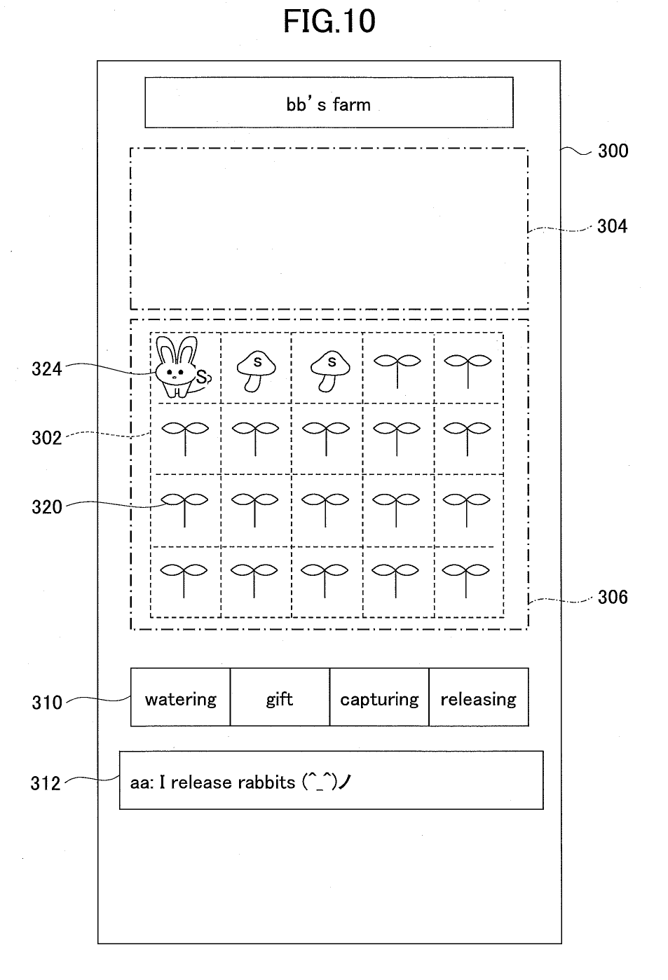

Further, when a player releases (sends) a possessing capture item on a grow item grown in a field of another player, the game management control unit 42 provides the capture item to appear on the grow item. FIG. 10 illustrates a status in which a player of a player name “aa” releases a capture item 324 to a farm of a player of a player name “bb” under a status that the farm of the player “bb” is displayed on the terminal device 1 of the player “aa”, for example. When a player displays another player's farm on the player's terminal device 1, the operation buttons 310 may be configured to include an operation button that can be used by the player to perform an operation to other player's farm.

Here, when a player succeeds in capturing the capture item that is released by another player, the capturing of the capture item can be counted as a capturing number of the player to clear the predetermined condition. With this configuration, players can be promoted to release capture items to fields of other players with each other in order to clear the predetermined condition and communication between the players can be activated.

Further, when a first player releases a predetermined capture item possessed by the first player to a grow item grown in a field of another second player to have the predetermined capture item appear on the grow item, the event game providing unit 44 may give a seed item of a predetermined grow item to the first player in accordance with a random selection based on a predetermined seed feeding probability. Here, the random selection based on the predetermined seed feeding probability means to randomly determine whether to give the seed item of the predetermined grow item based on a seed feeding probability “c” % and a non-seed feeding probability “100−c” %. The kind of a seed item of a grow item that is given when a capture item is release may be set in the event game information storing unit 62 for each of the event games, as will be explained later.

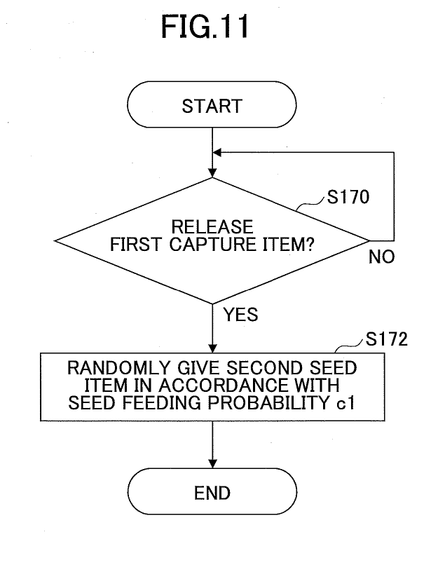

FIG. 11 is a flowchart illustrating an example of this process.

When a first player releases a first capture item, for example, under a condition that the first player displays a second player's farm on the terminal device 1 of the first player, on a grow item in the second player's farm, the event game providing unit 44 accepts the operation of the first player and provides the first capture item to appear on the corresponding grow item in the second player's field (YES in step S170). At this time, the event game providing unit 44 randomly gives a seed item of a second grow item (second seed), for example, to the first player in accordance with a seed feeding probability c1 (step S172).

Further, the event game providing unit 44 may randomly give a seed item of a predetermined grow item to the first player in accordance with a random selection based on a predetermined seed feeding probability when the first player helps to capture the predetermined capture item that appears on a grow item grown in another second player's field. Specifically, the capturing tool 326 as illustrated in FIG. 8 may be covered by the first player in the second player's field. In this case, the second player may capture the capture item by using the capturing tool 326 covered by the first player. The kind of a seed item of a grow item that is given when the capturing tool 326 is covered on a capture item may be set in the event game information storing unit 62 for each of the event games.

Next, an event game in which a probability varying item can be used is explained. When a probability varying item is given to a player, the player can possess the probability varying item. Specifically, the probability varying item is stored in the player information storing unit 68 as a possessing item of the player. The player can use the probability varying item by instructing to use the probability varying item from his/her terminal device 1. As will be described later, when a player uses a probability varying item, a display icon of the probability varying item may be displayed in the farm of the player so that other players can recognize it.

### Example 1

First, as an example, a case is explained in which, when a player is using a probability varying item permitted to be used in a current event game, an appearance probability of a predetermined capture item on a predetermined grow item grown at a field of the player is increased compared with a predetermined appearance probability based on a setting to the probability varying item.

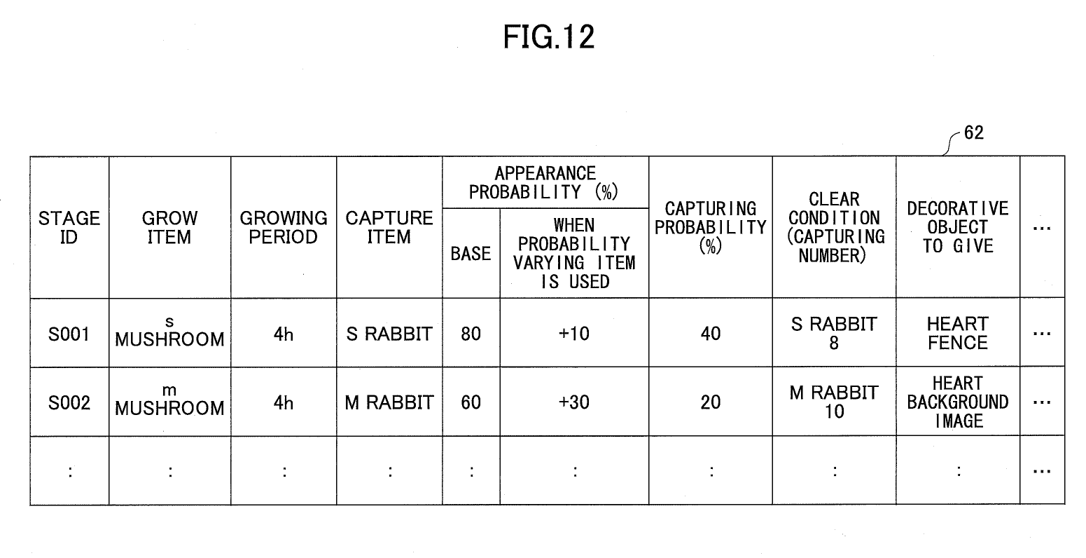

FIG. 12 is a view illustrating an example of an internal structure of the event game information storing unit 62 for the event game in which a probability varying item can be used.

The event game information storing unit 62 includes items (fields) such as “stage ID”, “grow item”, “growing period”, “capture item”, “appearance probability (%)”, “capturing probability (%)”, “clear condition (capturing number)”, “decorative object to give” or the like. Although not illustrated in the drawings, an item of “event game ID” that specifies the event game is also corresponded in the event game information storing unit 62.

The “stage ID” is data to specify the stage. The “grow item” indicates a grow item to grow in the stage. Although a name such as “s mushroom”, “m mushroom” or the like is illustrated here, the event game information storing unit 62 may store grow item ID that is information specifying the grow item. The “growing period” indicates a growing period necessary for the grow item to grow after being seeded.

The “capture item” indicates a capture item that appears on the grow item. Although a name such as “S rabbit”, “M rabbit” or the like is illustrated here, the event game information storing unit 62 may store capture item ID that is information specifying the capture item.

The “appearance probability (%)” indicates an appearance probability of the capture item. Here, in this example, the “appearance probability (%)” includes items such as “base” and “when probability varying item is used”. The “base” indicates a base appearance probability that is applied to all of the players who participate in the event game. The “when probability varying item is used” indicates a varying probability of the appearance probability of the capture item on the grow item grown at the field of the player when the player uses the probability varying item permitted to be used in the event game.

For example, in the stage ID “S001”, when the player grows the “s mushroom” and the “s mushroom” becomes capable of being harvested, the game management control unit 42 provides the “S rabbit” to appear on each “s mushroom” in accordance with a random selection based on an appearance probability of 80% for the player who does not use the probability varying item in his/her field. On the other hand, the game management control unit 42 provides the “S rabbit” to appear on each “s mushroom” in accordance with a random selection based on an appearance probability of 80+10=90% for the player who uses the probability varying item in his/her field. Thus, the player who uses the probability varying item can advantageously proceed with the event game compared with other players who do not use the probability varying item by using the probability varying item.

The “capturing probability (%)” indicates a capturing probability of the capture item. The “clear condition (capturing number)” indicates a clear condition for the stage, here, the number of capture items necessary to capture in order to clear the stage. The “decorative object to give” indicates a decorative object given to a player when the player satisfies the clear condition of the stage. Although a name such as “heart fence”, “heart background image” or the like is illustrated here, the event game information storing unit 62 may store decorative object ID that is information specifying the decorative object.

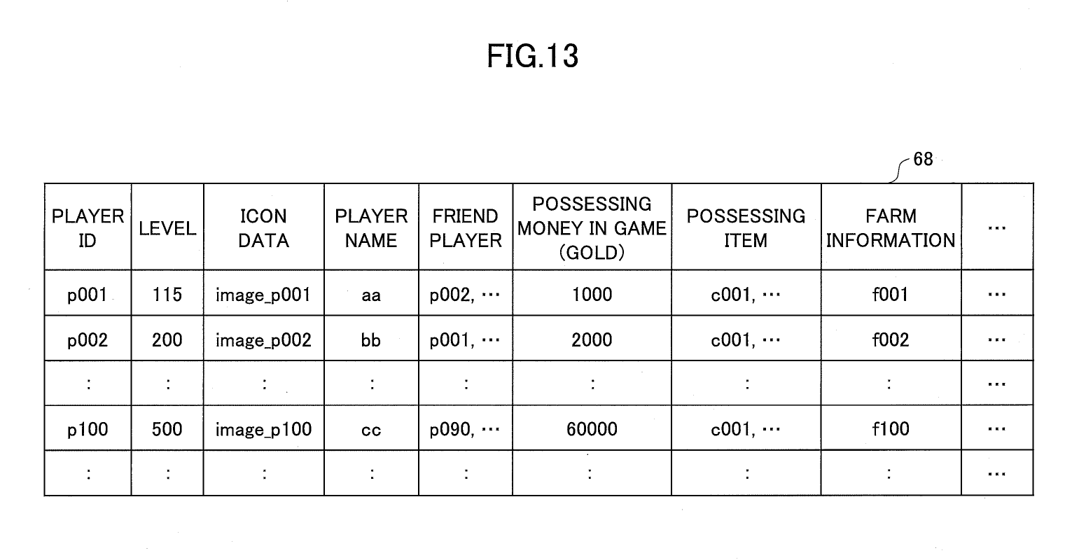

FIG. 13 is an example of an internal structure of the player information storing unit 68 of the embodiment.

The player information storing unit 68 includes items (fields) such as “player ID”, “level”, “icon data”, “player name”, “friend player”, “possessing money in game (gold)”, “possessing item”, “farm information” or the like.

The “player ID” is data to specify a player. The “level” indicates a level of the player in the game. The “icon data” is data to specify a display icon of the player. The “player name” is data of a display name of the player. The “friend player” indicates player ID of a friend player of the player. The “possessing money in game (gold)” indicates money in game possessed by the player. The “farm information” indicates farm ID of the player.

The “possessing item” indicates item ID of an item possessed by the player. As described above, when the player succeeds in capturing a capture item, the player can possess the capture item. Thus, when the player succeeds in capturing a capture item, the event game providing unit 44 stores item ID of the capture item as a possessing item of the player. Further, when the player releases one of the possessing capture items to a field of another player, the event game providing unit 44 stores item ID of the capture item as a non-possessing item at an area of the player information storing unit 68 corresponding to the player. In other words, when the player releases one of the possessing capture items to a field of another player, the event game providing unit 44 may delete the item ID of the capture item from an area of the player information storing unit 68 corresponding to the player.

When a seed item of a grow item is given to the player, the event game providing unit 44 stores item ID of the seed item of the grow item as a possessing item of the player at an area of the player information storing unit 68 corresponding to the player.

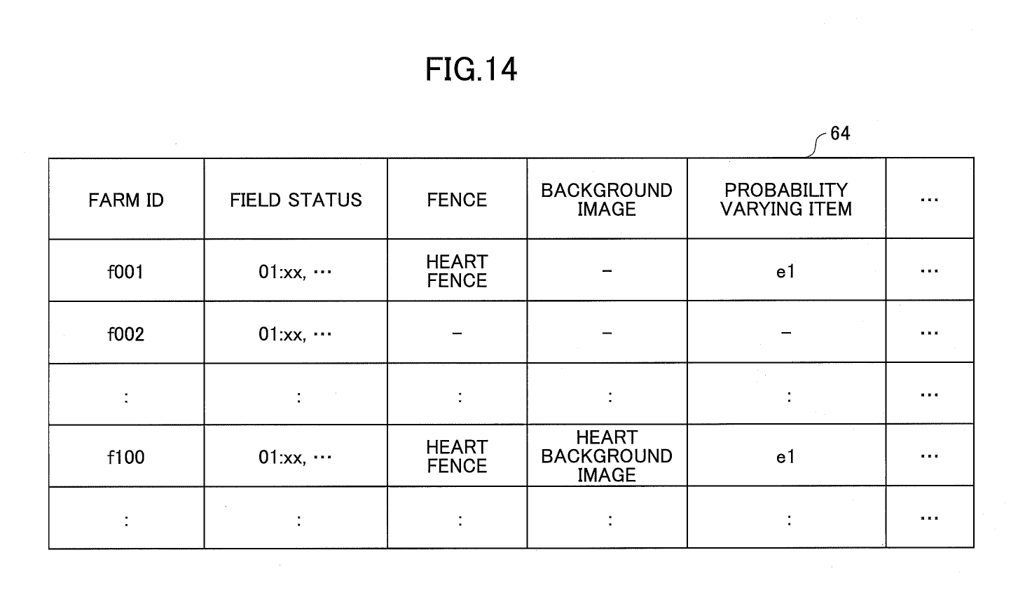

FIG. 14 is a view illustrating an example of an internal structure of the farm information storing unit 64 of the embodiment.

The farm information storing unit 64 includes items (fields) such as “farm ID”, “field status”, “fence”, “background image”, “probability varying item” or the like.

The “farm ID” is data to specify a farm. The “field status” indicates a status of each of the blocks of the farm. For example, when there a plurality of blocks 302 as illustrated in FIG. 5, ID is given to each of the blocks 302, and the farm information storing unit 64 stores a grow item planted at the block 302, a status of the grow item (whether it is growing, capable of being harvested or the like), a capture item if the capture item appears on the grow item, for each of the blocks 302.

The “fence” indicates a fence that is set in the farm. The “background image” indicates a background image set in the farm. The “probability varying item” indicates whether a “probability varying item” is used or not, and item ID of the probability varying item that is set in the farm. The item of the “probability varying item” may be included in the player information storing unit 68.

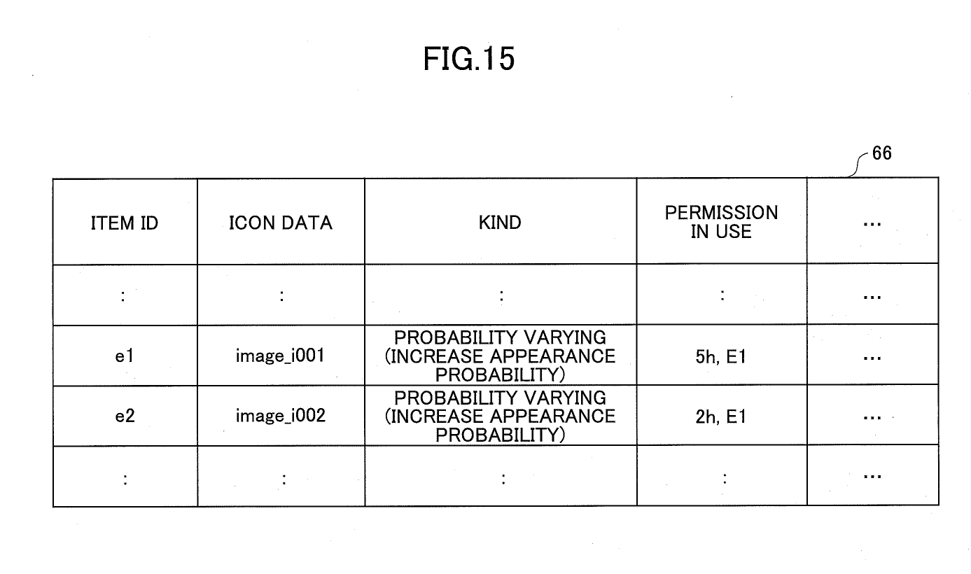

FIG. 15 is a view illustrating an example of an internal structure of the item information storing unit 66 of the embodiment.

The item information storing unit 66 includes items (fields) such as “item ID”, “icon data”, “kind”, “permission in use” or the like. The “item ID” is data to specify the item. The “icon data” is data to specify a display icon of the item. The “kind” indicates a kind or a function of the item. The “permission in use” indicates permissions in use such as a period or the number of times that the item can be used, an event in which the item is permitted to be used or the like. For example, an item with item ID “e1” is a probability varying item and has a function to increase the appearance probability of a capture item. Further, the item with item ID “e1” can be used for 5 hours after being set to be used and is permitted to be used in an event with event ID “E1”. Here, item ID of a probability varying item that is permitted to be used in the event game may be set in the event game information storing unit 62 (see FIG. 12).

Further, although FIG. 15 only illustrates an example of the probability varying item, the item information storing unit 66 may store information of a growing item, a capture item or the like.

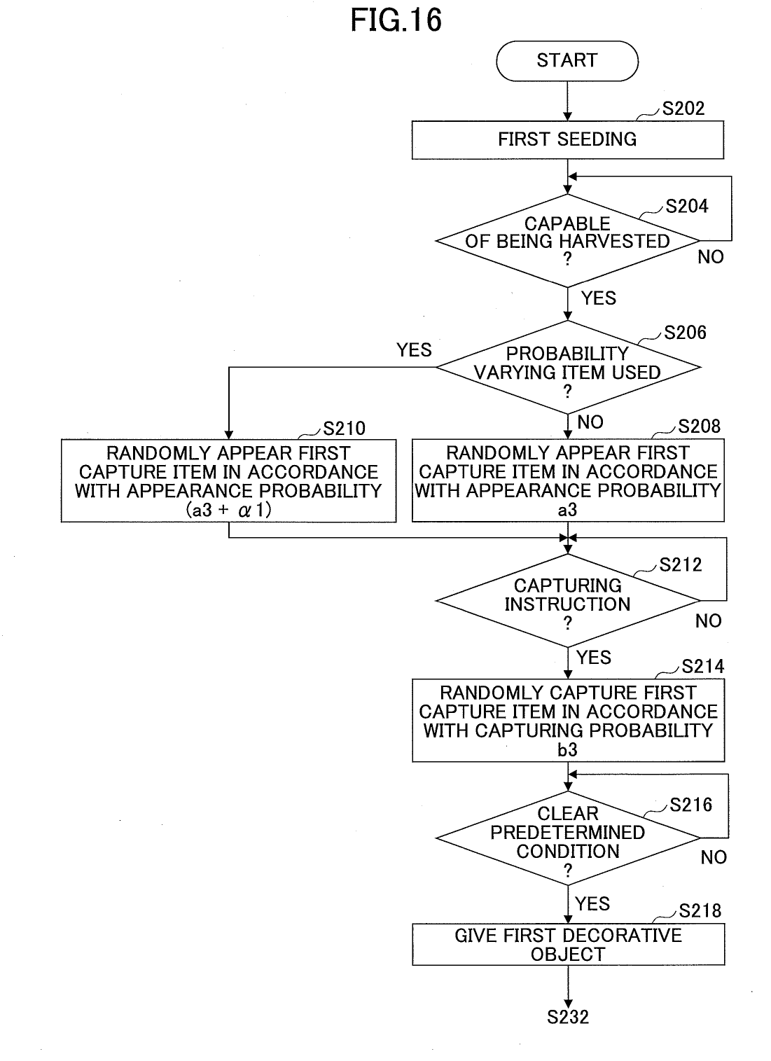

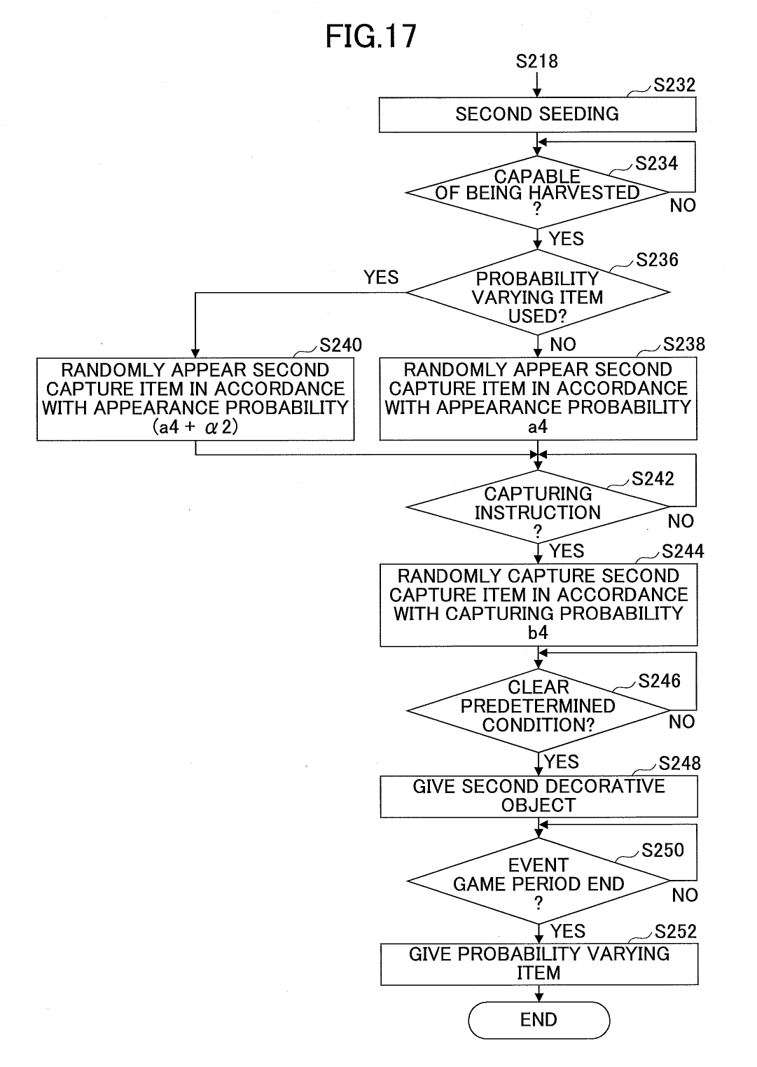

FIG. 16 and FIG. 17 are flowcharts illustrating an example of processing steps of the game control server apparatus 4 of the embodiment when a probability varying item can be used. FIG. 16 and FIG. 17 illustrate processing steps of the event game that are performed after the event game explained with reference to FIG. 6. Thus, there is a possibility that the player who is given the probability varying item at step S152 of FIG. 6 uses the probability varying item. Here, as the event game illustrated in FIG. 16 and FIG. 17 is different from the event game that is explained above with reference to FIG. 6, an object to grow, an object to capture, a decorative object that is given or the like is different from the case illustrated in FIG. 6.

First, when the player seeds seed items of a first grow item in his/her field (first seeding), the event game providing unit 44 accepts the operation of the player and displays a status in which the seeding is completed in the game screen 300 (FIG. 16, step S202). This process is the same as the process of step S102 of FIG. 6. Thereafter, when the first grow item becomes capable of being harvested (YES in step S204), the event game providing unit 44 determines whether the player is using a probability varying item (step S206).

When the player uses the probability varying item (YES in step S206), the event game providing unit 44 refers to the event game information storing unit 62 and randomly provides a first capture item to appear on the first grow item in accordance with a base appearance probability a3+an appearance probability α1 for the case when the probability varying item is used (step S210). On the other hand, when the player does not use the probability varying item (NO in step S206), the event game providing unit 44 refers to the event game information storing unit 62 and randomly provides the first capture item to appear on the first grow item in accordance with the base appearance probability a3 (step S208). Here, for the example illustrated in FIG. 12, the base appearance probability a3=80% and the appearance probability α1=+10% for the case when the probability varying item is used.

Thereafter, processes of step S212 to step S218 are performed similarly to the processes of step S112 to step S118 explained above with reference to FIG. 6. Here, in step S214, the event game providing unit 44 randomly captures the first capture item in accordance with a capturing probability b3 set in this event game.

Thereafter, similar to the first stage, processes of the second stage are performed. When the player seeds seed items of a second grow item in his/her field (second seeding), the event game providing unit 44 accepts the operation of the player and displays a status in which the seeding is completed in the game screen 300 (FIG. 17, step S232). This process is the same as the process of step S132 of FIG. 6. Thereafter, when the second grow item becomes capable of being harvested (YES in step S234), the event game providing unit 44 determines whether the player is using a probability varying item (step S236).

When the player uses the probability varying item (YES in step S236), the event game providing unit 44 refers to the event game information storing unit 62 and randomly provides the second capture item to appear on the second grow item in accordance with a base appearance probability a4+an appearance probability a2 for the case when the probability varying item is used (step S240). On the other hand, when the player does not use the probability varying item (NO in step S236), the event game providing unit 44 refers to the event game information storing unit 62 and randomly provides the second capture item to appear on the second grow item in accordance with the base appearance probability a4 (step S238). Here, for the example illustrated in FIG. 12, the base appearance probability a4=60% and the appearance probability α2=+30% for the case when the probability varying item is used.

Thereafter, processes of step S142 to step S152 are performed similarly to the processes of step S242 to step S252 explained above with reference to FIG. 6. Here, in step S244, the event game providing unit 44 randomly captures the second capture item in accordance with a capturing probability b4 set in this event game. Here, in this event game as well, thereafter, similar steps of a third stage, a fourth stage and the like may be performed.

### Example 2

Next, as another example, a case is explained in which, when a player is using a probability varying item permitted to be used in a current event game, a capturing probability of a predetermined capture item that appears in a field of the player is increased compared with a predetermined capturing probability based on a setting to the probability varying item.

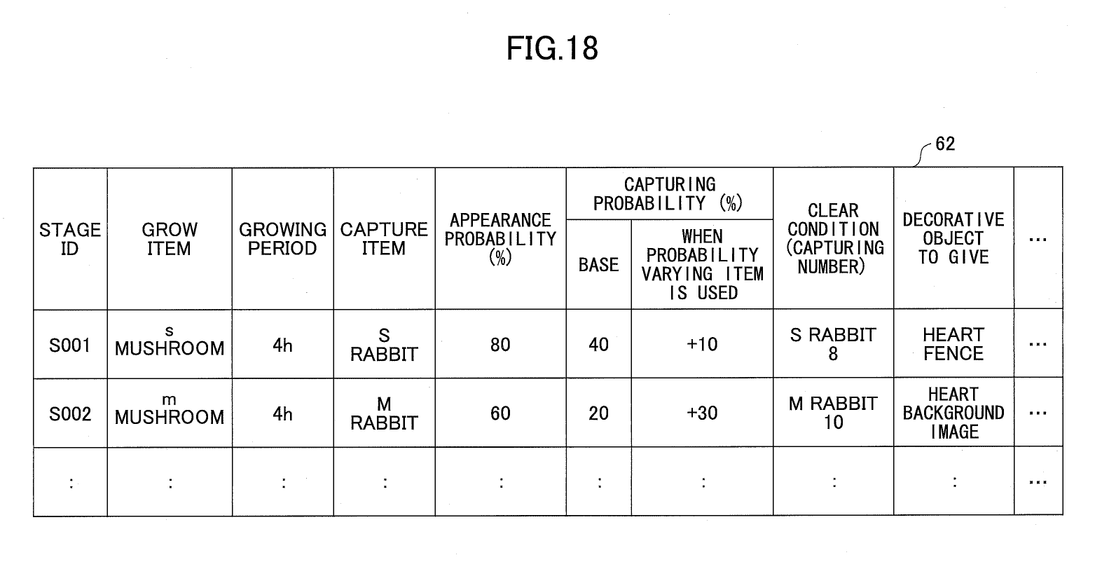

FIG. 18 is a view illustrating another example of an internal structure of the event game information storing unit 62 for the event game in which a probability varying item can be used.

Similar to the example illustrated in FIG. 12, the event game information storing unit 62 includes items (fields) such as “stage ID”, “grow item”, “growing period”, “capture item”, “appearance probability (%)”, “capturing probability (%)”, “clear condition (capturing number)”, “decorative object to give” or the like.

Here, in this example, the “capturing probability (%)”, not the “appearance probability (%)”, includes items such as “base” and “when probability varying item is used”. The “base” indicates a base capturing probability that is applied to all of the players who participate in the event game. The “when probability varying item is used” indicates a varying probability of the capturing probability of the predetermined capture item that appears in a field of the player when the player uses the probability varying item permitted to be used in the event game.

For example, in the stage ID “S001”, when the “S rabbit” appears on one of the grow items, the game management control unit 42 determines whether the “S rabbit” is captured in accordance with a random selection based on a capturing probability of 40% for a field of a player who does not use the probability varying item. On the other hand, the game management control unit 42 determines whether the “S rabbit” is captured in accordance with a random selection based on a capturing probability of 40+10=50% for a field of a player who uses the probability varying item. Thus, the player who possesses the probability varying item can advantageously proceed with the event game compared with other players who do not use the probability varying item by using the probability varying item.

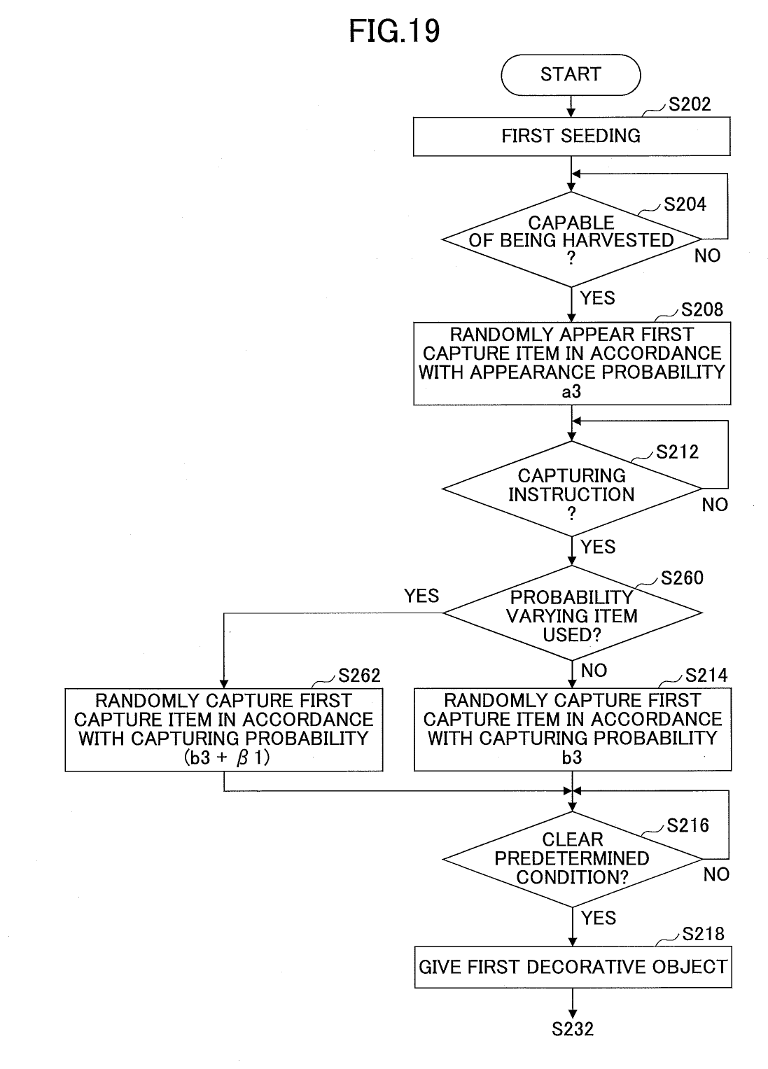

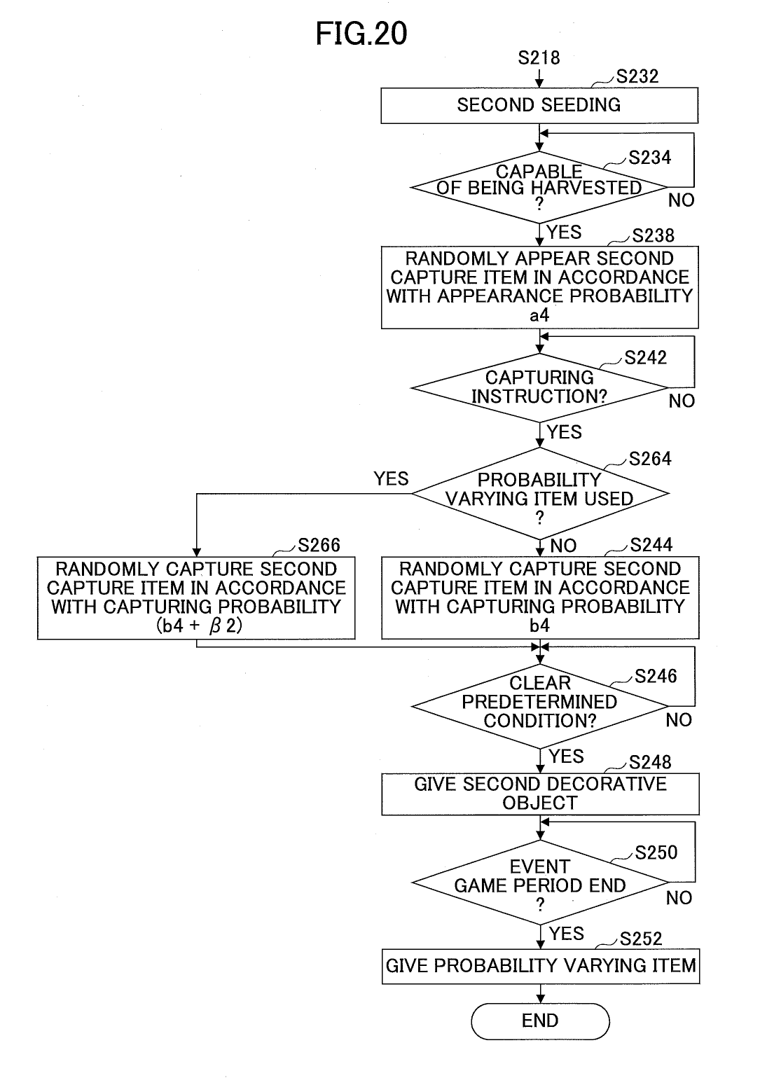

FIG. 19 and FIG. 20 are flowcharts illustrating another example of processing steps of the game control server apparatus 4 of the embodiment when a probability varying item can be used. The event game illustrated in FIG. 19 and FIG. 20 corresponds to the example of the event game illustrated in FIG. 16 and FIG. 17, and the same steps are given the same step numbers, and explanations are not repeated.

In this example, after YES in step S204 (FIG. 19), the event game providing unit 44 refers to the event game information storing unit 62 and randomly provides the first capture item to appear on the first grow item in accordance with the base appearance probability a3 (step S208).

On the other hand, after YES in step S212, the event game providing unit 44 determines whether the player is using a probability varying item (step S260).

When the player uses the probability varying item (YES in step S260), the event game providing unit 44 refers to the event game information storing unit 62 and randomly captures the first capture item in accordance with a base capturing probability b3+a capturing probability β1 for the case when the probability varying item is used (step S262). On the other hand, when the player does not use the probability varying item (NO in step S260), the event game providing unit 44 refers to the event game information storing unit 62 and randomly captures the first capture item in accordance with the base capturing probability b3 (step S214). Here, for the example illustrated in FIG. 18, the base capturing probability b3=40% and the capturing probability β31=+10% for the case when the probability varying item is used.

Further, after YES in step S234 (FIG. 20), the event game providing unit 44 refers to the event game information storing unit 62 and randomly provides the second capture item to appear on the second grow item in accordance with a base appearance probability a4 (step S238).

On the other hand, after YES in step S242, the event game providing unit 44 determines whether the player is using a probability varying item (step S264).

When the player uses the probability varying item (YES in step S264), the event game providing unit 44 refers to the event game information storing unit 62 and randomly captures the second capture item in accordance with a base capturing probability b4+a capturing probability β2 for the case when the probability varying item is used (step S266). On the other hand, when the player does not use the probability varying item (NO in step S264), the event game providing unit 44 refers to the event game information storing unit 62 and randomly captures the second capture item in accordance with the base capturing probability b4 (step S244). Here, for the example illustrated in FIG. 18, the base capturing probability b4=20% and the capturing probability β2=+30% for the case when the probability varying item is used.

### Example 3

Further, as another example, a case is explained in which when a first player releases a possessing predetermined capture item to a grow item grown in another second player's field to have the predetermined capture item appear on the grow item, if the second player is using a probability varying item permitted to be used in a current event game, a seed feeding probability of a seed item in the second player's field is increased compared with a predetermined seed feeding probability based on a setting to the probability varying item.

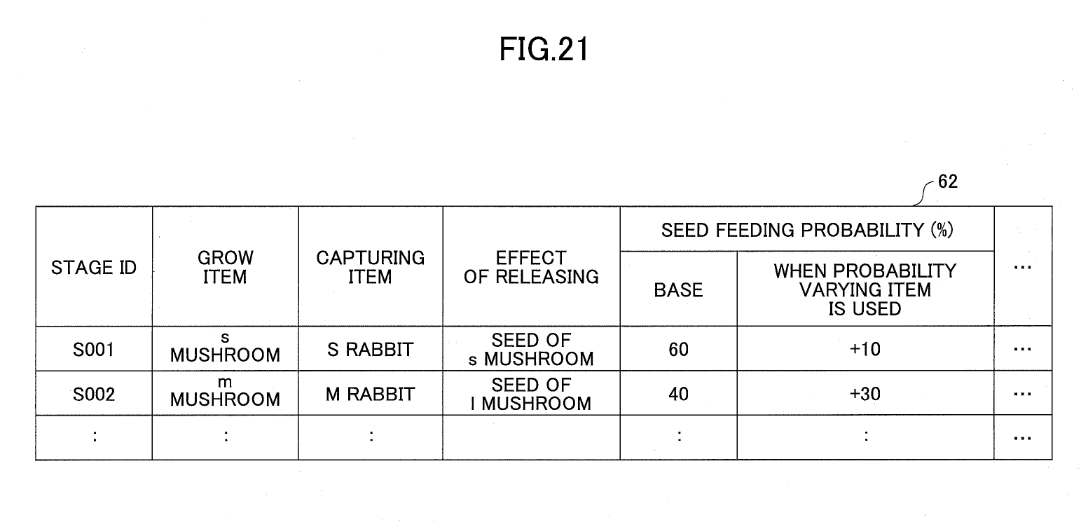

FIG. 21 is a view illustrating another example of an internal structure of the event game information storing unit 62 for the event game in which a probability varying item can be used.

Similar to the example illustrated in FIG. 12, the event game information storing unit 62 includes items (fields) such as the “stage ID”, the “grow item”, the “capture item” or the like. Further, the event game information storing unit 62 includes items such as “releasing effect”, “seed feeding probability (%)” or the like. Further, not illustrated in FIG. 21, similar to the example illustrated in FIG. 12, the event game information storing unit 62 may include items such as the “growing period”, the “appearance probability (%)”, the “capturing probability (%)”, the “clear condition (capturing number)”, the “decorative object to give” or the like in this example as well.

The “releasing effect” indicates a grow item whose seed item may be given to a first player when the first player releases a corresponding capture item to a grow item grown in a field of another second player. For example, it is set that when a first player releases the “S rabbit” to a grow item grown in a field of another second player in the stage ID “S001”, a “seed (item) of m mushroom” is randomly given to the first player based on a seed feeding probability set as the “seed feeding probability (%)”.

The “seed feeding probability (%)” includes items such as “base” and “when probability varying item is used”. The “base” indicates a base seed feeding probability that is applied to all of the players who participate in the event game. The “when probability varying item is used” indicates a varying probability of the seed feeding probability when the player uses the probability varying item permitted to be used in the event game.

For example, in the stage ID “S001”, if the second player does not use the probability varying item, the game management control unit 42 determines whether to give the “seed (item) of m mushroom” to the first player in accordance with a random selection based on a seed feeding probability of 60% every time the first player releases the “S rabbit” to the grow item grown in the second player's field. On the other hand, in the stage ID “S001”, when the second player uses the probability varying item, the game management control unit 42 determines whether to give the “seed (item) of m mushroom” to the first player in accordance with a random selection based on a seed feeding probability of 60+10=70% every time the first player releases the “S rabbit” to the grow item grown in the second player's field.

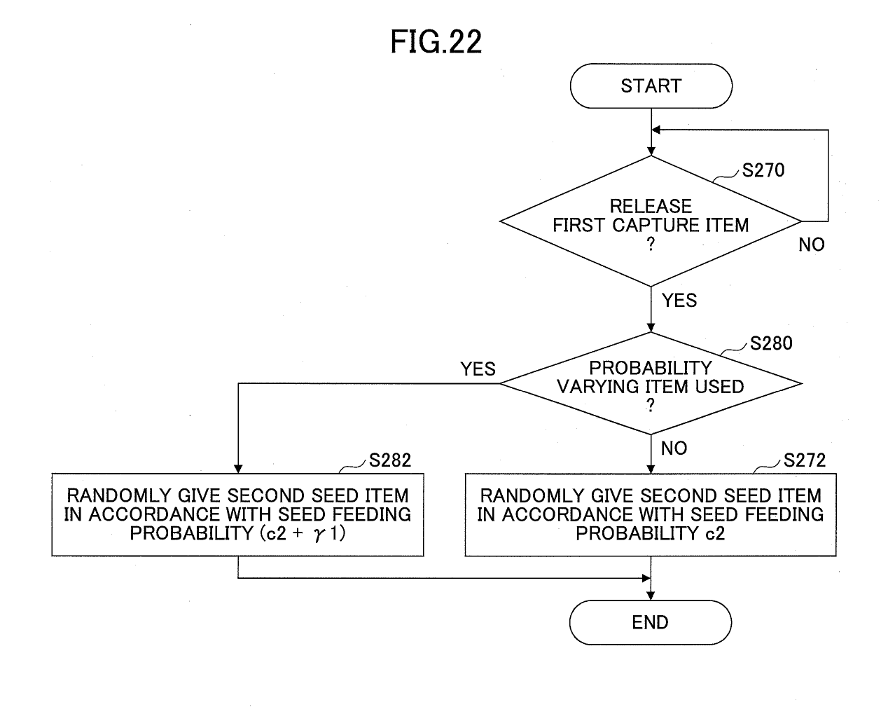

FIG. 22 is a flowchart illustrating another example of processing steps of the game control server apparatus 4 when a probability varying item can be used.

When a first player releases a first capture item, for example, on a grow item in a second player's field while displaying the second player's field on the first player's terminal device 1, the event game providing unit 44 accepts the operation of the first player and provides the first capture item to appear on the corresponding grow item at the second player's field (YES in step S270). At this time, the event game providing unit 44 determines whether the second player uses a probability varying item (step S280).

When the second player uses the probability varying item (YES in step S280), the event game providing unit 44 refers to the event game information storing unit 62 and randomly gives a seed item of a second grow item (second seed) to the first player in accordance with a base seed feeding probability c2+a seed feeding probability γ1 for the case when the probability varying item is used (step S282). On the other hand, when the second player does not use the probability varying item (NO in step S280), the event game providing unit 44 refers to the event game information storing unit 62 and randomly gives the seed item of the second grow item (second seed) to the first player in accordance with the base seed feeding probability c2 (step S272). Here, for the example illustrated in FIG. 22, the base seed feeding probability c2=60% and the appearance probability γ1=+10% for the case when the probability varying item is used.

### Example 4

Further, as another example, a case is explained in which when a first player helps to capture a predetermined capture item that appears on a grow item grown in another second player's field, if the second player is using a probability varying item permitted to be used in a current event game, a seed feeding probability of a seed item at the second player's field is increased compared with a predetermined seed feeding probability based on a setting to the probability varying item.

Here, in the event game, for example, it is assumed that a seed item of a grow item that is set as an object to grow in a first stage can be purchased by money in game possessed by each of the players. On the other hand, a seed item of a grow item that is set as an object to grow in a second stage or later stage cannot be purchased by the money in game. Instead, for example, as described above, it is assumed that the seed item of the grow item that is set as the object to grow in the second stage or the later stage is given to the first player when the first player releases a capture item to the second player's field or helps the second player in the event game.

Further, when the capture item, that is released by the first player or is covered with a net by the first player, is set as an object to capture in a current stage, it may be set that the seed item given to the first player is a seed item of a grow item that is set as an object to grow in another stage subsequent to or later than the current stage. For example, for the example illustrated in FIG. 12, the “S rabbit” is set as an object to capture in a first stage “S001” and the “m mushroom” is set as an object to grow in a second stage “S002”. Thus, when the first player releases the “S rabbit” or covers a net on the “S rabbit”, a seed item of the “m mushroom” may be given, for example.

With this configuration, players can be promoted to release capture items or help with each other in order to obtain desired seed items and communication between the players can be activated.

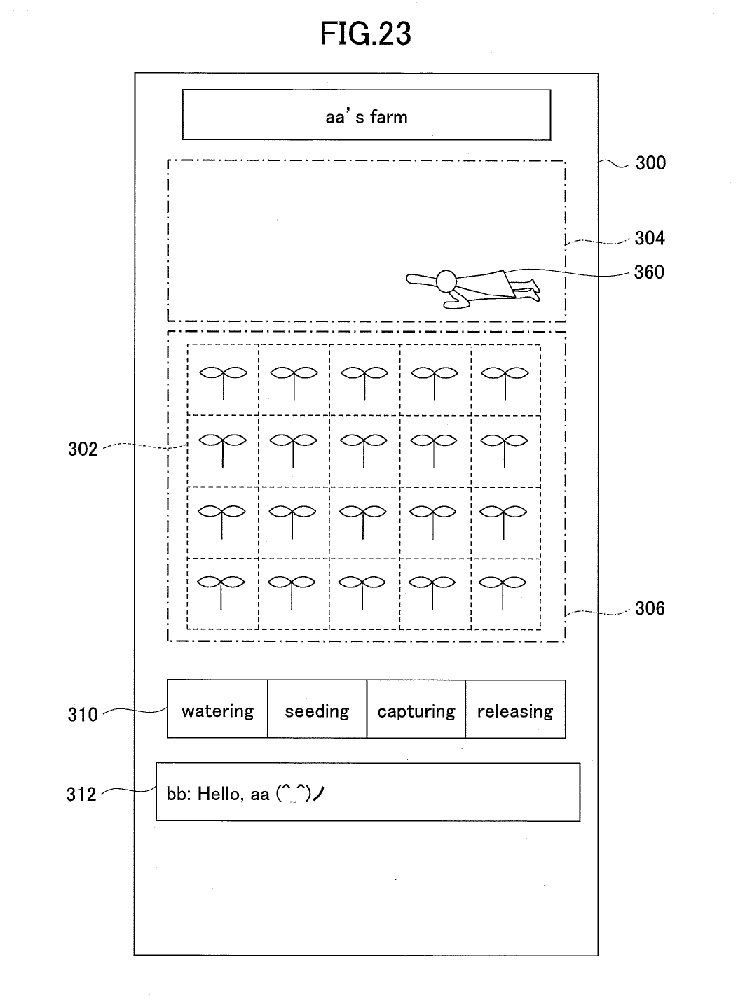

Further, when a player uses a probability varying item, the event game providing unit 44 displays a display icon of the probability varying item in the player's farm under a status that the display icon is visible and recognizable by other players. FIG. 23 illustrates a status in which a probability varying item 360 is displayed at the background image 304 of the game screen 300. With this configuration, other players can recognize that the player is using the probability varying item.

Thus, when the first player releases the capture item in the second player's field or helps the second player, the probability to obtain a seed item becomes higher when the second player uses the probability varying item 360 compared with a case when the second player does not use the probability varying item. Thus, for the second player, it becomes easier to obtain help or cooperation from other players by using the probability varying item 360. For example, other players may release a lot of capture items in the second player's field so that the second player can be easily clear the predetermined condition. Thus, the player who possesses the probability varying item can advantageously proceed with the event game by using the probability varying item compared with other players who do not use the probability varying item.

Further, in the above embodiment, an example is explained in which the seed feeding probability of the seed item in the second player's field to be larger than the predetermined seed feeding probability when the second player uses the probability varying item that is permitted to be used in the current event game. However, a configuration may be adopted in which the seed feeding probability of the seed item in the second player's field to be larger than the predetermined seed feeding probability when the first player uses the probability varying item that is permitted to be used in the current event game. Thus, in this case as well, the player who possesses and uses the probability varying item can advantageously proceed with the event game by using the probability varying item compared with other players who do not use the probability varying item.

As described above, according to the game control server apparatus 4 of the embodiment, motivation of a player to clear an event game as early as possible can be increased by giving a decorative object, which is a reward, to the player at the time when the player clears the predetermined condition within an event game period. Further, meanwhile, motivation of the player to continue the event game even after the player clears the predetermined condition of the event game can also be increased by giving a very attractive reward, that is a probability varying item, capable of being used in a following or later event game to a player whose performance is good based on an action of the player from a start to an end of the period of the event game.

According to the embodiment, a technique can be provided capable of improving motivation of a player to continue an event game even after the player clears a predetermined condition of the event game while giving a decorative object, which is a reward, to the player at the time when the player clears the predetermined condition within an event game period.

Constituents of the terminal device 1 and the game control server apparatus 4 in FIG. 4 indicate not a structure of hardware units but blocks of functional units. The individual constituents of the terminal device 1 and the game control server apparatus 4 may be embodied by arbitrary combinations of hardware and software, typified by a CPU of an arbitrary computer, a memory, a program loaded in the memory so as to embody the constituents illustrated in the drawings, a storage unit for storing the program such as a hard disk, and an interface for network connection. It may be understood by those skilled in the art that methods and devices for the embodiment allow various modifications. Further, functions performed by the game control server apparatus 4 may be unnecessarily actualized in a single apparatus and may be distributed in a plurality of apparatuses.

Although a preferred embodiment of the game control server apparatus has been specifically illustrated and described, it is to be understood that minor modifications may be made therein without departing from the spirit and scope of the invention as defined by the claims.

The present invention is not limited to the specifically disclosed embodiments, and numerous variations and modifications may be made without departing from the spirit and scope of the present invention.

As explained with reference to Example 1 to Example 4 in the above embodiment, the probability varying item may have a function to increase an appearance probability of a capture item, a capturing probability of a capture item, a seed feeding probability of a seed item of a grow item or the like, by being used. Each of the probability varying items may have a function to increase only one of these probabilities, may have a function to increase two or more of these probabilities, or may have a function to increase all of these probabilities. The function of each of the probability varying items may be set in the item information storing unit 66, for example. Further, in addition to these probabilities, the probability varying item may have a function to vary another probability in a process that is controlled by a predetermined probability in an event game toward a direction that a player can clear a predetermined condition easier in each stage.

Further, as illustrated in FIG. 12 or the like, the varying probability for the case when the probability varying item is used may be different for each of the stages even when the same probability varying item is used. For example, for the example illustrated in FIG. 12, the base appearance probability is set to be lower as the stage proceeds. On the other hand, as illustrated in FIG. 12, the varying probability for the case when the probability varying item is used may be set to be higher as the stage proceeds. Further, a stage in which the probability varying item can be used and a stage in which the probability varying item cannot be used may be set.

Further, although an example is explained in the above embodiment in which a varying probability for the case when the probability varying item is used is set in the event game information storing unit 62, the varying probability for the case when the probability varying item is used may be set to be corresponded with each of the probability varying items in the item information storing unit 66. Further, varying probabilities may be different for different probability varying items.

Further, the game may be performed by any of a “browser type” and an “application type”. In the browser type, screen transition data (View data) that describes a display control content of a series of screens in accordance with the game progression is managed at the game control server apparatus 4 side, data such as an HTML data document, images corresponded to the HTML data document or the like are sent to the terminal device in response to a request of obtaining data by an input operation from the terminal device 1, and the data are displayed in the web browser on the terminal device 1. Meanwhile, in the application type, game application software (application program) is previously downloaded to the terminal device 1 from the game control server apparatus 4 or the like, the game application software is executed on the terminal device 1, and screen data is generated to be displayed based on screen transition data included in the game application software that is stored in the terminal device 1 after being downloaded and data obtained from the server by an input operation as a trigger.

What is claimed is:

1. A game control server apparatus connected to a plurality of terminal devices of a plurality of players via a network to enable communication between players and providing a game in which each of the players grows an item in a field of the player, the game control server apparatus comprising:
an event game providing unit that provides an event game in which a predetermined capture item is provided to appear on a predetermined grow item grown at a field of each of the players and the predetermined capture item is captured based on a capturing instruction from each of the players, a period being set for the event game;
an object providing unit that gives a predetermined decorative object for decorating a field to a player at a timing when a performance result by the player of capturing the capture item in the field of the player satisfies a predetermined condition while the event game is being held; and
a probability varying item providing unit that evaluates a performance of each of the players in a first event game based on a predetermined action performed by the respective player from a start to an end of the period of the first event game in the first event game, and gives a probability varying item that is permitted to be used in a following or later event game to a player whose performance is good,
wherein the event game providing unit provides the predetermined capture item on the predetermined grow item in accordance with a random selection based on a predetermined appearance probability, and
wherein when a player uses the probability varying item that is permitted to be used in a current event game, the event game providing unit increases an appearance probability of the predetermined capture item on the predetermined grow item grown in the field of the player to be larger than the predetermined appearance probability based on a setting to the probability varying item.

2. A game control server apparatus connected to a plurality of terminal devices of a plurality of players via a network to enable communication between players and providing a game in which each of the players grows an item in a field of the player, the game control server apparatus comprising:
an event game providing unit that provides an event game in which a predetermined capture item is provided to appear on a predetermined grow item grown at a field of each of the players and the predetermined capture item is captured based on a capturing instruction from each of the players, a period being set for the event game;
an object providing unit that gives a predetermined decorative object for decorating a field to a player at a timing when a performance result by the player of capturing the capture item in the field of the player satisfies a predetermined condition while the event game is being held;
a probability varying item providing unit that evaluates a performance of each of the players in a first event game based on a predetermined action performed by the respective player from a start to an end of the period of the first event game in the first event game, and gives a probability varying item that is permitted to be used in a following or later event game to a player whose performance is good; and
a player information storing unit that stores information of an item possessed by each of the players in correspondence with the respective player,
wherein the event game providing unit gives a seed item of a predetermined grow item to a first player in accordance with a random selection based on a predetermined seed feeding probability when the first player releases a possessing predetermined capture item on a grow item grown in a field of another second player to have the predetermined capture item appear on the grow item, and
wherein when the first player or the second player uses the probability varying item that is permitted to be used in a current event game, the event game providing unit increases a seed feeding probability of the seed item in the field of the second player to be larger than the predetermined seed feeding probability and gives the seed item of the predetermined grow item to the first player in accordance with a random selection based on the increased seed feeding probability.

3. A game control server apparatus connected to a plurality of terminal devices of a plurality of players via a network to enable communication between players and providing a game in which each of the players grows an item in a field of the player, the game control server apparatus comprising:
an event game providing unit that provides an event game in which a predetermined capture item is provided to appear on a predetermined grow item grown at a field of each of the players and the predetermined capture item is captured based on a capturing instruction from each of the players, a period being set for the event game;
an object providing unit that gives a predetermined decorative object for decorating a field to a player at a timing when a performance result by the player of capturing the capture item in the field of the player satisfies a predetermined condition while the event game is being held; and
a probability varying item providing unit that evaluates a performance of each of the players in a first event game based on a predetermined action performed by the respective player from a start to an end of the period of the first event game in the first event game, and gives a probability varying item that is permitted to be used in a following or later event game to a player whose performance is good,
wherein the event game providing unit gives a seed item of a predetermined grow item to a first player in accordance with a random selection based on a predetermined seed feeding probability when the first player helps to capture a predetermined capture item that appears on a grow item grown in a field of another second player, and
wherein when the first player or the second player uses the probability varying item that is permitted to be used in a current event game, the event game providing unit increases a seed feeding probability of the seed item in the field of the second player to be larger than the predetermined seed feeding probability and gives the seed item of the predetermined grow item to the first player in accordance with a random selection based on the increased seed feeding probability.

4. The game control server apparatus according to claim 1,
wherein the event game providing unit captures the predetermined capture item in accordance with a random selection based on a predetermined capturing probability by a capturing instruction from a player, and
wherein when a player uses the probability varying item that is permitted to be used in a current event game, the event game providing unit increases a capturing probability of the predetermined capture item that appears in the field of the player to be larger than the predetermined capturing probability based on a setting to the probability varying item.

5. The game control server apparatus according to claim 1,
wherein when a player uses the probability varying item, the event game providing unit displays image data of the probability varying item such that the image data is visible by other players in a field of the player.

6. The game control server apparatus according to claim 1,
wherein the probability varying item providing unit provides a point to each of the players based on the predetermined action performed by the respective player in the event game from the start to the end of the period of the event game and evaluates the performance of each of the players in the first event game by a ranking based on the points provided to each of the players.

7. The game control server apparatus according to claim 2,
wherein the event game providing unit captures the predetermined capture item in accordance with a random selection based on a predetermined capturing probability by a capturing instruction from a player, and
wherein when a player uses the probability varying item that is permitted to be used in a current event game, the event game providing unit increases a capturing probability of the predetermined capture item that appears in the field of the player to be larger than the predetermined capturing probability based on a setting to the probability varying item.

8. The game control server apparatus according to claim 2,
wherein when a player uses the probability varying item, the event game providing unit displays image data of the probability varying item such that the image data is visible by other players in a field of the player.

9. The game control server apparatus according to claim 2,
wherein the probability varying item providing unit provides a point to each of the players based on the predetermined action performed by the respective player in the event game from the start to the end of the period of the event game and evaluates the performance of each of the players in the first event game by a ranking based on the points provided to each of the players.

10. The game control server apparatus according to claim 3,
wherein the event game providing unit captures the predetermined capture item in accordance with a random selection based on a predetermined capturing probability by a capturing instruction from a player, and
wherein when a player uses the probability varying item that is permitted to be used in a current event game, the event game providing unit increases a capturing probability of the predetermined capture item that appears in the field of the player to be larger than the predetermined capturing probability based on a setting to the probability varying item.

11. The game control server apparatus according to claim 3,
wherein when a player uses the probability varying item, the event game providing unit displays image data of the probability varying item such that the image data is visible by other players in a field of the player.

12. The game control server apparatus according to claim 3,
wherein the probability varying item providing unit provides a point to each of the players based on the predetermined action performed by the respective player in the event game from the start to the end of the period of the event game and evaluates the performance of each of the players in the first event game by a ranking based on the points provided to each of the players.

13. A non-transitory computer-readable recording medium having recorded thereon a program for a game control server apparatus connected to a plurality of terminal devices of a plurality of players via a network to enable communication between players and providing a game in which each of the players grows an item in a field of the player, to execute functions comprising:
an event game providing function that provides an event game in which a predetermined capture item is provided to appear on a predetermined grow item grown at a field of each of the players and the predetermined capture item is captured based on a capturing instruction from each of the players, a period being set for the event game;
an object providing function that gives a predetermined decorative object for decorating a field to a player at a timing when a performance result by the player of capturing the capture item in the field of the player satisfies a predetermined condition while the event game is being held; and
a probability varying item providing function that evaluates a performance of each of the players in a first event game based on a predetermined action performed by the respective player from a start to an end of the period of the first event game in the first event game, and gives a probability varying item that is permitted to be used in a following or later event game to a player whose performance is good,
wherein the event game providing function provides the predetermined capture item on the predetermined grow item in accordance with a random selection based on a predetermined appearance probability, and
wherein when a player uses the probability varying item that is permitted to be used in a current event game, the event game providing function increases an appearance probability of the predetermined capture item on the predetermined grow item grown in the field of the player to be larger than the predetermined appearance probability based on a setting to the probability varying item.

14. A non-transitory computer-readable recording medium having recorded thereon a program for a game control server apparatus connected to a plurality of terminal devices of a plurality of players via a network to enable communication between players and providing a game in which each of the players grows an item in a field of the player, to execute functions comprising:
an event game providing function that provides an event game in which a predetermined capture item is provided to appear on a predetermined grow item grown at a field of each of the players and the predetermined capture item is captured based on a capturing instruction from each of the players, a period being set for the event game;
an object providing function that gives a predetermined decorative object for decorating a field to a player at a timing when a performance result by the player of capturing the capture item in the field of the player satisfies a predetermined condition while the event game is being held;
a probability varying item providing function that evaluates a performance of each of the players in a first event game based on a predetermined action performed by the respective player from a start to an end of the period of the first event game in the first event game, and gives a probability varying item that is permitted to be used in a following or later event game to a player whose performance is good; and
a player information storing function that stores information of an item possessed by each of the players in correspondence with the respective player,
wherein the event game providing function gives a seed item of a predetermined grow item to a first player in accordance with a random selection based on a predetermined seed feeding probability when the first player releases a possessing predetermined capture item on a grow item grown in a field of another second player to have the predetermined capture item appear on the grow item, and
wherein when the first player or the second player uses the probability varying item that is permitted to be used in a current event game, the event game providing function increases a seed feeding probability of the seed item in the field of the second player to be larger than the predetermined seed feeding probability and gives the seed item of the predetermined grow item to the first player in accordance with a random selection based on the increased seed feeding probability.

15. A non-transitory computer-readable recording medium having recorded thereon a program for a game control server apparatus connected to a plurality of terminal devices of a plurality of players via a network to enable communication between players and providing a game in which each of the players grows an item in a field of the player, to execute functions comprising:
an event game providing function that provides an event game in which a predetermined capture item is provided to appear on a predetermined grow item grown at a field of each of the players and the predetermined capture item is captured based on a capturing instruction from each of the players, a period being set for the event game;
an object providing function that gives a predetermined decorative object for decorating a field to a player at a timing when a performance result by the player of capturing the capture item in the field of the player satisfies a predetermined condition while the event game is being held; and
a probability varying item providing function that evaluates a performance of each of the players in a first event game based on a predetermined action performed by the respective player from a start to an end of the period of the first event game in the first event game, and gives a probability varying item that is permitted to be used in a following or later event game to a player whose performance is good,
wherein the event game providing function gives a seed item of a predetermined grow item to a first player in accordance with a random selection based on a predetermined seed feeding probability when the first player helps to capture a predetermined capture item that appears on a grow item grown in a field of another second player, and
wherein when the first player or the second player uses the probability varying item that is permitted to be used in a current event game, the event game providing function increases a seed feeding probability of the seed item in the field of the second player to be larger than the predetermined seed feeding probability and gives the seed item of the predetermined grow item to the first player in accordance with a random selection based on the increased seed feeding probability.
